(19) United States
(12) Patent Application Publication
(10) Pub. No.: US 2025/0035389 A1
(43) Pub. Date: Jan. 30, 2025

(54) CONCENTRATED SOLAR POWER ELECTRIC POWER PLANT HEAT EXCHANGE MODULE

(71) Applicant: UCHICAGO ARGONNE, LLC, Chicago, IL (US)

(72) Inventors: David M. France, Lombard, IL (US); Dileep Singh, Naperville, IL (US); Wenhua Yu, Darien, IL (US)

(21) Appl. No.: 18/916,390

(22) Filed: Oct. 15, 2024

Related U.S. Application Data
(63) Continuation of application No. 16/810,428, filed on Mar. 5, 2020.

(51) Int. Cl. F28F 9/02; B22F 1/10; B33Y 80/00; F28F 1/10; F28F 21/04; F28F 21/08; G06T 17/00

(52) U.S. Cl. CPC F28F 9/027; B22F 1/10; B33Y 80/00; F28F 1/10; F28F 21/04; F28F 21/08; G06T 17/00

(57) ABSTRACT

An additively manufactured heat exchanger adapted for use in extreme environments, such as a concentrated solar power (CSP) electric power plant. The heat exchanger receives a liquid heat transfer fluid at a high temperature and high pressure. The heat exchanger efficiently exchanges heat with a working fluid flowing in a cross-flow or a counter-flow configuration. A first set of channels of the heat exchanger receives liquid heat transfer fluid, such as corrosive molten salt, and a second set of channels receives working fluid, such as super critical carbon dioxide. The heat exchanger transfers heat from the liquid heat transfer fluid to the working fluid.

### CROSS-REFERENCE TO RELATED APPLICATIONS

This application is a continuation of U.S. patent application Ser. No. 16/810,428, filed on Mar. 5, 2020, the entire disclosure of which is incorporated herein by this reference thereto.

### STATEMENT REGARDING FEDERALLY SPONSORED RESEARCH OR DEVELOPMENT

The United States (“U.S.”) Government has rights in this invention pursuant to Contract No. DE-AC02-06CH11357 between the U.S. Department of Energy and UChicago Argonne, LLC, representing Argonne National Laboratory.

### TECHNICAL FIELD OF THE INVENTION

The present disclosure generally relates to a system for transferring heat from one fluid to another fluid and, more particularly, to a system for transferring heat from one fluid heated by concentrated solar power (hereinafter “CSP”) to another fluid.

### BACKGROUND OF THE INVENTION

CSP electric plants utilize a liquid heat transfer fluid (hereinafter “the HTF”) to transfer thermal energy collected from a solar field to a working fluid of a heat exchanger. High temperature molten salts are often used as the HTF and efficient heat exchange is required between the HTF and the working fluid of the heat exchanger. However, molten salts are highly corrosive which greatly limits the materials that can be used to construct heat exchangers for this application. Ceramics have emerged as promising materials due to their good performance at high temperatures and resistance to corrosion, but manufacturing ceramic heat exchangers on the scale required for a CSP electric plant remains a challenge.

### SUMMARY OF THE INVENTION

In accordance with one aspect, a heat exchanger adapted to receive high temperature, high pressure, and corrosive fluids includes a body having an interior volume, a first set of channels extending through the body, a second set of channels extending through the body such that the second set of channels is spaced from the first set of channels by a distance, a first set of headers integrally formed with the body and in fluid communication with each channel in the first set of channels, and a second set of headers integrally formed with the body and in fluid communication with each channel in the second set of channels. Each channel in the first set of channels having a first inlet aperture, a first inlet portion, a first outlet aperture, a first outlet portion, and a first conduit extending between the first inlet portion and the first outlet portion. The first conduit having a uniform shape along a length of the first conduit. Each channel in the second set of channels having a second inlet aperture, a second inlet portion, a second outlet aperture, a second outlet portion, and a second conduit extending between the second inlet portion and the second outlet portion. The second conduit having a uniform shape along a length of the second conduit.

In a second aspect, a heat exchanger module adapted to receive high temperature, high pressure, and corrosive fluids includes a plurality of heat exchangers. Each heat exchanger in the plurality of heat exchangers includes a body, a first set of channels integrally formed through the body, a first set of headers integrally formed with the body and fluidly coupled to the first set of channels, a second set of channels integrally formed through the body, and a second set of headers integrally formed with the body and fluidly coupled to the second set of channels. A first heat exchanger of the plurality of heat exchangers is fluidly coupled to a second heat exchanger of the plurality of heat exchangers in series, in parallel, or in series and in parallel.

In a third aspect, a heat exchanger adapted to receive high temperature, high pressure, and corrosive fluids includes a body, a first set of channels adapted to receive a first fluid having a first temperature and a first pressure, a second set of channels adapted to receive a second fluid having a second temperature and a second pressure. The body includes an interior volume defined by a top side, a bottom side, a first side, a second side, a third side, and a fourth side. Each channel in the first set of channels includes a first inlet, a first outlet, a first conduit extending between the first inlet and the first outlet, and a first set of headers at least partially disposed within the interior volume of the body and fluidly coupled to the first set of channels. The first conduit has a uniform shape from the first inlet to the first outlet. Each channel in the second set of channels includes a second inlet, a second outlet, a second conduit extending between the second inlet and the second outlet, and a second set of headers at least partially disposed within the interior volume of the body and coupled to the second set of channels. In the third aspect, the first set of channels and the second set of channels are disposed in the interior volume of the body such that each channel in the first set of channels is arranged in parallel with each channel in the second set of channels.

In a fourth aspect, a method of manufacturing a heat exchanger using additive manufacturing includes (a) creating, via a modeling application, a model of the heat exchanger based on a set of parameters, the molding application being stored on a memory of a computing device and executed on a processor of the computing device. The method includes (b) distributing a layer of powder on a building platform. The method then includes (c) selectively applying a binding agent, via a carriage, to the layer of powder based at least in part on the model of the heat exchanger created by the modeling application thereby creating a printing area, where some particles in the layer of powder are bound together via the binding agent, and a material area, where each particle in the layer of powder is separate from each other particle in the layer of powder. The method also includes (d) translating the building platform in a direction away from the carriage by a distance, the distance being greater than a thickness of the layer of powder. Finally, the method includes (e) repeating steps (b)-(d) until the heat exchanger is formed.

In further accordance with any one or more of the foregoing first, second, third, or fourth aspects, a heat exchanger and/or a method of manufacturing a heat exchanger may further include any one or more of the following preferred forms.

In some forms, the heat exchanger includes a set of storage channels integrally formed with and extending through the body. Each storage channel in the set of storage channels being adapted to receive a thermal storage material. The set of storage channels being disposed between the first set of channels and the second set of channels.

In some forms, at least one of the first conduit or the second conduit includes a semi-elliptical cross-section along the length of the first conduit or the second conduit, respectively.

In some forms, the first conduit has a height of approximately two (2) to six (6) millimeters. The second conduit has a height of approximately two (2) to six (6) millimeters.

In some forms, a shape of the first inlet portion and a shape of the first outlet portion are substantially similar to the shape of the first conduit. A shape of the second inlet portion and a shape of the second outlet portion are substantially similar to the shape of the second conduit. The shape of at least one of the first inlet portion or the second inlet portion includes a semi-elliptical cross-section.

In some forms, the first set of channels is adapted to receive a first fluid having a temperature between 500° C. and 800° C. The second set of channels is adapted to receive a second fluid having a temperature between 500° C. and 800° C. The first fluid being different from the second fluid.

In some forms, the second set of channels is adapted to receive a corrosive fluid and the body is ceramic material.

In some forms, the first inlet portion has a first shape. The first outlet portion has a second shape. The second inlet portion has a third shape. The second outlet portion has a fourth shape. The first and second shapes are different from the third and fourth shapes.

In some forms, each header in the first set of headers includes a first vertical portion and at least one horizontal portion. Each horizontal portion of the at least one first horizontal portion being in fluid communication with the first vertical portion.

In some forms, each header in the second set of headers includes a second vertical portion and at least one second horizontal portion. Each horizontal portion of the at least one second horizontal portion being in fluid communication with the second vertical portion.

In some forms, a header in the first set of headers is in fluid communication with the first inlet portion of each channel in the first set of channels. Another header in the first set of headers is in fluid communication with the first outlet portion of each channel in the first set of channels.

In some forms, a header in the second set of headers is in fluid communication with the second inlet portion of each channel in the second set of channels. Another header in the second set of headers is in fluid communication with the second outlet portion of each channel in the second set of channels.

In some forms, the first conduit of each channel in the first set of channels is substantially linear and the second conduit of each channel in the second set of channels is substantially linear.

In some forms, the first set of channels and the second set of channels are arranged in a channel matrix through the body. The channel matrix having alternating rows of the first set of channels and the second set of channels.

In some forms, the first set of channels and the second set of channels are arranged in a channel matrix through the body such that each channel in the first set of channels is arranged in parallel with each channel in the second set of channels.

In some forms, the first set of headers are arranged on the body in a first orientation such that a first fluid received by the first set of headers flows in a first direction.

In some forms, the second set of headers are arranged on the body in a second orientation such that a second fluid received by the second set of headers flows in a second direction that is opposite the first direction.

In some forms, the first set of channels of the first heat exchanger is coupled to the first set of channels of the second heat exchanger. The second set of channels of the first heat exchanger is coupled to the second set of channels in the second heat exchanger.

In some forms, the first heat exchanger of the plurality of heat exchangers is spaced away from the second heat exchanger of the plurality of heat exchangers by a distance.

In some forms, a first header in the first set of headers of the first heat exchanger is coupled to a second header in the first set of headers of the heat exchanger. A first header in the second set of headers of the first heat exchanger is coupled to a second header in the second set of headers of the second heat exchanger.

In some forms, the heat exchanger includes a set of storage channels where each storage channel in the set of storage channels is adapted to receive a phase change material. The set of storage channels being disposed between the first set of channels and the second set of channels.

In some forms, the body has a length equal to one (1) meter.

In some forms, a center of each channel in the first set of channels is spaced from a center of each channel in the second set of channels by a distance of less than or equal to 7.2 millimeters.

In some forms, each channel in the first set of channels has a diameter of approximately ten (10) millimeters and a height of approximately two (2) to six (6) millimeters. Each channel in the second set of channels has a diameter of approximately ten (10) millimeters and a height of approximately two (2) to six (6) millimeters.

In some forms, each channel in the first set of channels has a generally rectangular shape and each corner of the generally rectangular shape is rounded. Each channel in the second set of channels has a generally rectangular shape and each corner of the generally rectangular shape is rounded.

In some forms, each channel in the first set of channels has a generally rectangular shape where the shorter edges of the generally rectangular shape are elliptical. Each channel in the second set of channels has a generally rectangular shape where the shorter edges of the generally rectangular shape are elliptical.

In some forms, the first set of headers are arranged on the body in a first orientation such that the first fluid received by the first set of headers flows in a first direction.

In some forms, the second set of headers are arranged on the body in a second orientation such that the second fluid received by the second set of headers flows in a second direction that is opposite of the first direction.

In some forms, selectively applying the binding agent includes applying the binding agent to the layer of powder such that the printing area is continuous.

In some forms, selectively applying the binding agent includes applying the binding agent to the layer of powder such that the printing area includes at least one void.

In some forms, the at least one void corresponds to at least one of (a) a channel in the first set of channels, (b) a channel in the second set of channels, (c) a header in the first set of headers, or (d) a header in the second set of headers.

### BRIEF DESCRIPTION OF THE DRAWINGS

Examples of the invention will now be described with reference to the accompanying drawings, in which:

FIG. 1A is a perspective view of an example heat exchanger module, constructed in accordance with the teachings of the present disclosure;

FIG. 1B is a perspective view of another example heat exchanger module, constructed in accordance with the teachings of the present disclosure;

FIG. 2 is a perspective view positively illustrating the negative space of a first set of channels and a first set of headers disposed within the heat exchanger module of FIG. 1A, constructed in accordance with the teachings of the present disclosure;

FIG. 3 is a perspective view illustrating the negative space of a second set of channels and a second set of headers disposed within the heat exchanger module of FIG. 1A, constructed in accordance with the teachings of the present disclosure;

FIG. 4A is a side view of the heat exchanger module of FIG. 1A, constructed in accordance with the teachings of the present disclosure;

FIG. 4B is a side view of the heat exchanger module of FIG. 1B, constructed in accordance with the teachings of the present disclosure;

FIG. 5A is a side view of the heat exchanger module of FIG. 1A, constructed in accordance with the teachings of the present disclosure;

FIG. 5B is a side view of the heat exchanger module of FIG. 1B, constructed in accordance with the teachings of the present disclosure;

FIG. 6A is a front view of the heat exchanger module of FIG. 1A, constructed in accordance with the teachings of the present disclosure;

FIG. 6B is a front view of the heat exchanger module of FIG. 1B, constructed in accordance with the teachings of the present disclosure;

FIG. 7A is a rear view of the heat exchanger module of FIG. 1A, constructed in accordance with the teachings of the present disclosure;

FIG. 7B is a rear view of the heat exchanger module of FIG. 1B, constructed in accordance with the teachings of the present disclosure;

FIG. 8A is a top view of the heat exchanger module of FIG. 1A, constructed in accordance with the teachings of the present disclosure;

FIG. 8B is a top view of the heat exchanger module of FIG. 1B, constructed in accordance with the teachings of the present disclosure;

FIG. 9A is a bottom view of the heat exchanger module of FIG. 1A, constructed in accordance with the teachings of the present disclosure;

FIG. 9B is a bottom view of the heat exchanger module of FIG. 1B, constructed in accordance with the teachings of the present disclosure;

FIG. 10 is a cross-section of the heat exchanger module of FIG. 1A or 1B along line A-A showing various sets of example channels, constructed in accordance with the teachings of the present disclosure;

FIG. 11 is a cross-section of the heat exchanger module of FIG. 10 within ellipse B showing a detailed view of a single channel of the heat exchanger of FIG. 1A or 1B, constructed in accordance with the teachings of the present disclosure;

FIG. 12 is a cross-section of another example single, heat exchanger module along line A-A having a set of storage channels disposed between the various sets of channels, constructed in accordance with the teachings of the present disclosure;

FIG. 13 is a perspective view of an example modular heat exchanger coupled together in series, constructed in accordance with the teachings of the present disclosure;

FIG. 14 is a perspective view of another example modular heat exchanger coupled together in series, constructed in accordance with the teachings of the present disclosure;

FIG. 15 is a perspective view of an example modular heat exchanger coupled together in parallel, constructed in accordance with the teachings of the present disclosure;

FIG. 16 is a flow chart illustrating an example method of manufacturing a heat exchanger module, in accordance with the teachings of the present disclosure;

FIG. 17 is a schematic illustrating a concentrated solar power plant including at least one example heat exchanger;

FIG. 18 is a graph depicting temperature profiles including average outlet temperatures of various channels at the corner of a heat exchanger module;

FIG. 19 is a graph depicting temperature profiles including average outlet temperatures of various channels in the interior of a heat exchanger module;

FIG. 20 is a graph depicting an average outlet temperature for channels containing a heat transfer fluid where rows of seven channels are shown with channels 1-7 closest to a corner of a heat exchanger module and channels 43-49 away from the corners of the heat exchanger module; and

FIG. 21 is a graph depicting an average outlet temperature for channels containing a working fluid with seven channel rows, as illustrated in FIG. 20.

### DESCRIPTION OF SOME EXAMPLES

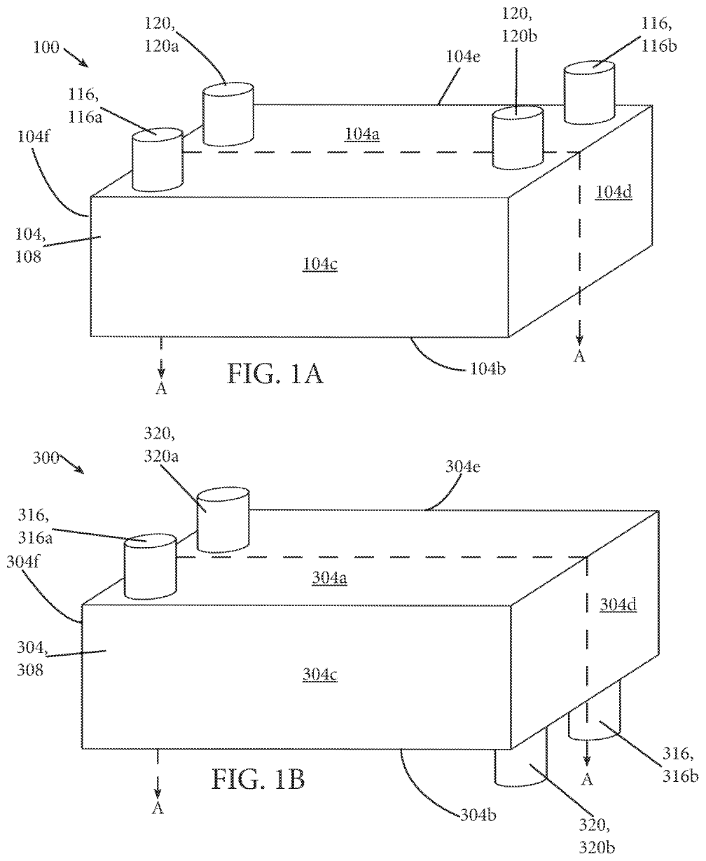

FIG. 1A illustrates a perspective view of an example heat exchanger 100 (heat exchanger and heat exchanger module are used interchangeably throughout the application) constructed in accordance with the teachings of the present disclosure. In particular, the heat exchanger 100 of FIG. 1A includes a body 104 having a top side 104a, a bottom side 104b, a first side 104c, a second side 104d, a third side 104e, and a fourth side 104f. So configured, the top side 104a, the bottom side 104b, and the first, second, third, and fourth sides 104c-f form an outer surface 108 of the body 104 that surrounds an interior volume 112. The body 104 also includes a first set of headers 116 at least partially disposed within the interior volume 112 of the body 104 and a second set of headers 120 at least partially disposed within the interior volume 112 of the body 104. The first and second sets of headers 116, 120 are oriented on the body 104 such that fluid flowing through the first set of headers 116 flows in a first direction and fluid flowing through the second set of headers 120 flows in a second direction that is opposite the first direction.

The first set of headers 116 includes a first header 116a and a second header 116b, each extending from the top side 104a of the body 104, and the second set of headers 120 includes a first header 120a and a second header 120b, each extending from the top side 104a of the body 104. In the example illustrated in FIG. 1A, the first header 116a of the first set of headers 116 is disposed toward an intersection of the first side 104c and the fourth side 104f of the body 104, and the second header 116b of the first set of headers 116 is disposed toward an intersection of the second side 104d and the third side 104e of the body 104. The first header 120a of the second set of headers 120 is disposed toward an intersection of the third side 104e and the fourth side 104f of the body 104, and the second header 120b in the second set of headers 120 is disposed toward an intersection of the first side 104c and the second side 104d of the body 104. So configured, a first fluid entering the first header 116a of the first set of headers 116 may flow from the first side 104c of the body 104 toward the third side 104e of the body 104, and a second fluid entering the first header 120a of the second set of headers 120 may flow from the third side 104e of the body 104 toward the first side 104c of the body 104. However, the first and second sets of headers 116, 120 can be arranged in different orientations in other examples.

In particular, FIG. 1B illustrates another example heat exchanger 300 that is constructed in accordance with the teachings of the present disclosure. The heat exchanger 300 of FIG. 1B is similar to the heat exchanger 100 of FIG. 1A, except for variations in the orientation of the first and second sets of headers 116, 120. Thus, for ease of reference, and to the extent possible, the same or similar components of the heat exchanger 300 of FIG. 1B will retain the same reference numbers as outlined above with respect to the heat exchanger 100 of FIG. 1A, although the reference numbers will be increased by 200.

The heat exchanger 300 of FIG. 1B, like the heat exchanger 100 of FIG. 1A, includes a body 304 having a top side 304a, a bottom side 304b, a first side 304c, a second side 304d, a third side 304e, and a fourth side 304f. So configured, the top side 304a, the bottom side 304b, and the first, second, third, and fourth sides 304c-f form an outer surface 308 of the body 304 that surrounds an interior volume 312. The body 304 includes a first set of headers 316 at least partially disposed within the interior volume 312 of the body 304 and a second set of headers 320 at least partially disposed within the interior volume 312 of the body 304. The first and second sets of headers 316, 320 are oriented on the body 304 such that fluid flowing through the first set of headers 316 flows in a first direction and fluid flowing through the second set of headers 320 flows in a second direction that is opposite the first direction. In particular, the first set of headers 316 includes a first header 316a extending from the top side 304a of the body 304 and a second header 316b extending from the bottom side 304b of the body 304, and the second set of headers 320 includes a first header 320a extending from the top side 304a of the body 304 and a second header 320b extending from the bottom side 304b of the body 304.

In the example illustrated in FIG. 1B, the first header 316a of the first set of headers 316 extends from the top side 304a of the body 304 and is disposed toward an intersection of the first side 304c and the fourth side 304f of the body 304, and the second header 316b of the first set of headers 316 extends from the bottom side 304b of the body 304 and is disposed toward an intersection of the second side 304d and the third side 304e of the body 304. The first header 320a of the second set of headers 320 extends from the top side 304a of the body 304 and is disposed toward an intersection of the third side 304e and the fourth side 304f of the body 304, and the second header 320b in the second set of headers 320 extends from the bottom side 304b of the body 304 and is disposed toward an intersection of the first side 304c and the second side 304d of the body 304. So configured, a first fluid entering the first header 316a may flow from the first side 304c of the body 304 toward the third side 304e of the body 304, and a second fluid entering the first header 320a of the second set of headers 320 may flow from the third side 104e of the body 104 toward the first side 104c of the body 104. This is called a “counter-flow” configuration in heat exchanger technology and is the most effective flow configuration.

While the first and second headers 116, 120 of the heat exchanger 100 of FIG. 1A and the first and second headers 316, 320 of the heat exchanger 300 of FIG. 1B have been discussed and illustrated as being oriented in a counter-flow configuration, the first and second headers 116, 120, 316, 320 can be oriented in different flow configurations in other examples. For example, the first and second headers 116, 120, 316, 320 can be oriented in a parallel flow configuration, a cross-flow configuration, etc.

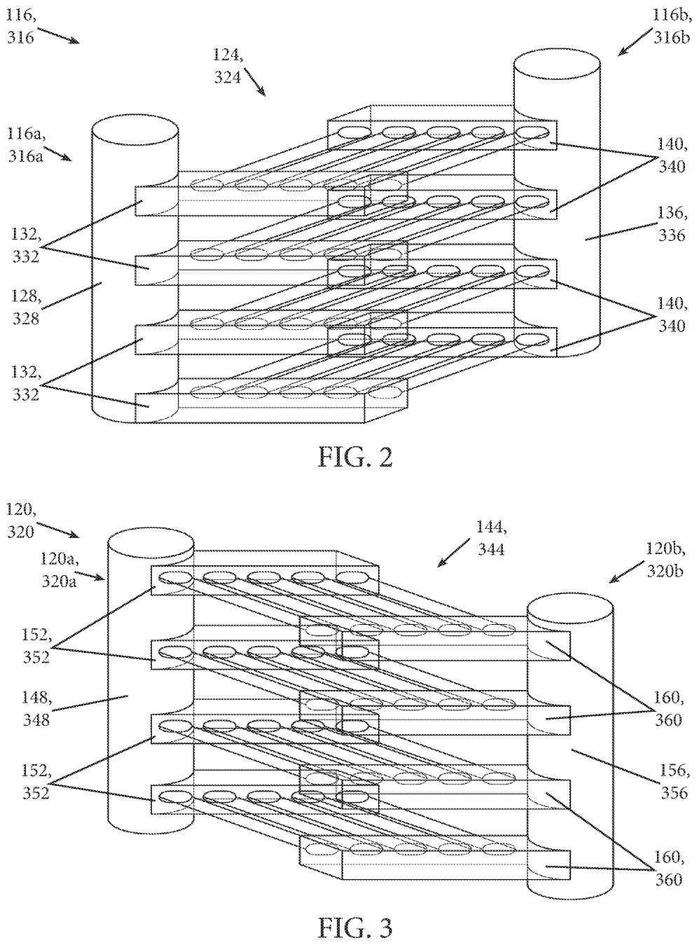

Turning now to FIGS. 2 and 3, which illustrate the negative space within the bodies 104, 304 of the heat exchangers 100, 300 of FIGS. 1A and 1B. In other words, the fluid flow paths illustrated in FIGS. 2 and 3 are empty spaces within the body 104, 304 of the heat exchangers 100, 300 illustrated in FIGS. 1A and 1B. Further, the negative spaces illustrated in FIG. 2 correspond to the first set of headers 116, 316 and the negative spaces illustrated in FIG. 3 correspond to the second set of headers 120, 320, which are rotated from the negative spaces illustrated in FIG. 2 by 90 degrees. In particular, FIG. 2 illustrates the first set of headers 116, 316 and a first set of channels 124, 314 extending through the body 104, 304 of the heat exchanger 100, 300. The first set of headers 116, 316 includes the first header 116a, 316a and the second header 116b, 316b, each of which may contain further components, as illustrated in FIG. 2. For example, the first header 116a, 316a includes a first vertical portion 128, 328 and at least one first horizontal portion 132, 332. Each first horizontal portion in the at least one first horizontal portion 132, 332 is fluidly coupled to the first vertical portion 128, 328. In particular, each horizontal portion in the at least one first horizontal portion 132, 332 extends transversely from the first vertical portion 128, 328 such that each horizontal portion in the at least one first horizontal portion 132, 332 is spaced away from every other horizontal portion. For example, a first horizontal portion 132, 332 can be spaced away from a second horizontal portion 132, 332 by a distance that is substantially equal to a height of any horizontal portion in the at least one first horizontal portion 132, 332. So configured, a horizontal portion of another set of headers may be disposed between each horizontal portion in the at least one first horizontal portion 132, 332 thereby allowing for a variety of fluid flow patterns to be created in the heat exchanger 100, 300.

Similarly, the second header 116b, 316b of the first set of headers 116, 316 includes a second vertical portion 136, 336 and at least one second horizontal portion 140, 340. Each horizontal portion in the at least one second horizontal portion 136, 336 is fluidly coupled to the second vertical portion 136, 336. In particular, each horizontal portion in the at least one second horizontal portion 140, 340 extends transversely from the second vertical portion 136, 336 such that each horizontal portion in the at least one second horizontal portion 140, 340 is spaced away from every other horizontal portion. For example, a third horizontal portion 140, 340 can be spaced away from a fourth horizontal portion 140, 340 by a distance that is substantially equal to a height of any horizontal portion in the at least one second horizontal portion 140, 340. Further, each horizontal portion in the at least one second horizontal portion 140, 340 can reside on the same horizontal plane as each horizontal portion in the at least one first horizontal portion 132, 332.

As illustrated in FIG. 2, the first header 116a, 316a and the second header 116b, 316b of the first set of headers 116, 316 are spaced from one another by a distance and extending there between is the first set of channels 124, 324. The first set of channels 124, 324 provides a fluid connection between the first header 116a, 316a and the second header 116b, 316b of the first set of headers 116, 316. So configured, the first fluid entering the first header 116a, 316a of the first head of headers 116, 316 passes through the first vertical portion 128, 328 and into each of the at least one first horizontal portions 132, 332. From each of the at least one first horizontal portions 132, 332, the first fluid flows through the first set of channels 124, 324 to each of the at least one second horizontal portions 140, 340 and out through the second vertical portion 136, 336 of the first set of headers 116, 316. The number of channels in the first set of channels 124, 324 depends on various factors such as, for example, the length of the heat exchanger 100, 300, the width of the heat exchanger 100, 300, the size of each channel, the desired energy output of the heat exchanger 100, 300, and any other parameters that are suitable. In the example illustrated in FIG. 2, the first set of channels 124, 324 includes five (5) channels extending between each horizontal portion in the at least one first horizontal portion 132, 332 and each horizontal portion in the at least one second horizontal portion 140, 340. However, the first set of channels 124, 324 may include more or less channels than as illustrated in FIG. 2.

Turning now to FIG. 3, which illustrates the second set of headers 120, 320 and a second set of channels 144, 344 extending through the body 104, 304 of the heat exchanger 100, 300. Similar to the first set of headers 116, 316, the second set of headers 120, 320 includes the first header 120a, 320a and the second header 120b, 320b, each of which may contain further components. For example, the first header 120a, 320a includes a first vertical portion 148, 348 and at least one first horizontal portion 152, 352. Each horizontal portion in the at least one first horizontal portion 152, 352 is fluidly coupled to the first vertical portion 148, 348. In particular, each horizontal portion in the at least one first horizontal portion 152, 352 extends transversely from the first vertical portion 148, 348 such that each horizontal portion in the at least one first horizontal portion 152, 352 is spaced away from every other horizontal portion. For example, a first horizontal portion 152, 352 can be spaced away from a second horizontal portion 152, 352 by a distance that is substantially equal to a height of any horizontal portion in the at least one first horizontal portion 152, 352. So configured, a horizontal portion of another set of headers may be disposed between each horizontal portion in the at least one first horizontal portion 152, 352 thereby allowing for a variety of fluid flow patterns to be created in the heat exchanger 100, 300.

Similarly, the second header 120b, 320b of the second set of headers 120, 320 includes a second vertical portion 156, 356 and at least one second horizontal portion 160, 360. Each second horizontal portion in the at least one second horizontal portion 160, 360 is fluidly coupled to the second vertical portion 156, 356. In particular, each second horizontal portion in the at least one second horizontal portion 160, 360 extends transversely from the second vertical portion 156, 356 such that each second horizontal portion in the at least one second horizontal portion 160, 360 is spaced away from each second horizontal portion. For example, a third horizontal portion 160, 360 can be spaced away from a fourth horizontal portion 160, 360 by a distance that is substantially equal to a height of any horizontal portion in the at least one second horizontal portion 160, 360. Further, each horizontal portion in the at least one second horizontal portion 160, 360 can reside on the same horizontal plane as each horizontal portion in the at least one first horizontal portion 152, 352.

As illustrated in FIG. 3, the first header 120a, 320a and the second header 120b, 320b of the second set of headers 120, 320 are spaced from one another by a distance and extending there between is the second set of channels 144, 344. The second set of channels 144, 344 provides a fluid connection between the first header 120a, 320a and the second header 120b, 320b of the second set of headers 120, 320. So configured, the second fluid entering the first header 120a, 320a of the first set of headers 120, 320 passes through the first vertical portion 148, 348 and into each horizontal portion of the at least one first horizontal portion 152, 352. From each horizontal portion of the at least one first horizontal portion 152, 352, the second fluid flows through the second set of channels 144, 344 to each of the at least one second horizontal portions 160, 360 and out through the second vertical portion 156, 356 of the second set of headers 120, 320. The number of channels in the second set of channels 144, 344 depends on various factors such as, for example, the length of the heat exchanger 100, 300, the width of the heat exchanger 100, 300, the size of each channel, the desired energy output of the heat exchanger 100, 300, and any other parameters that are suitable. In the example illustrated in FIG. 3, the second set of channels 144, 344 includes five (5) channels extending between each horizontal portion in the at least one first horizontal portion 152, 352 and each horizontal portion in the at least one second horizontal portion 160, 360. However, the second set of channels 144, 344 may include more or less channels than as illustrated in FIG. 3.

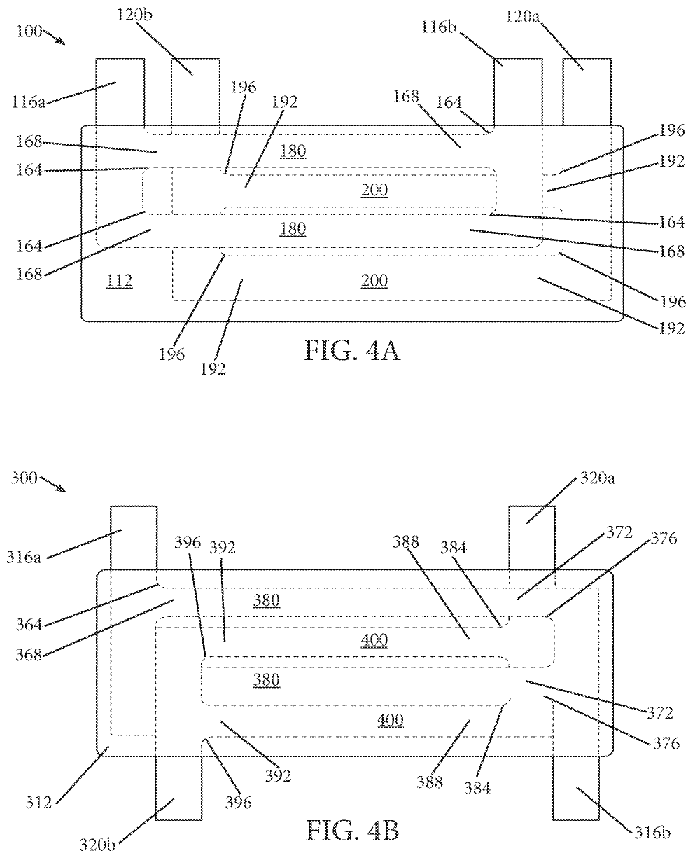

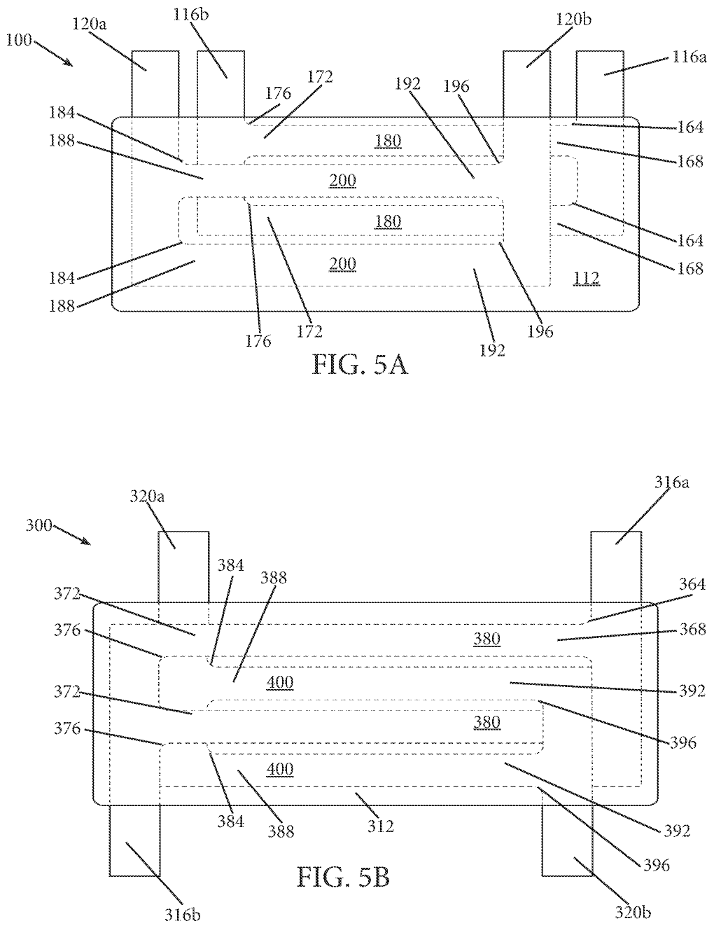

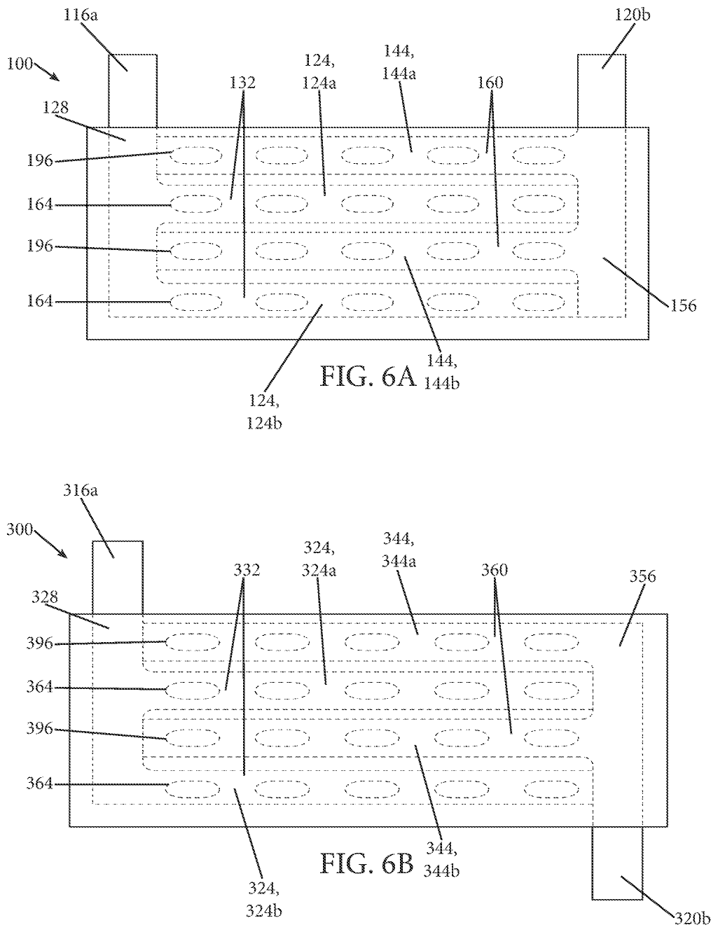

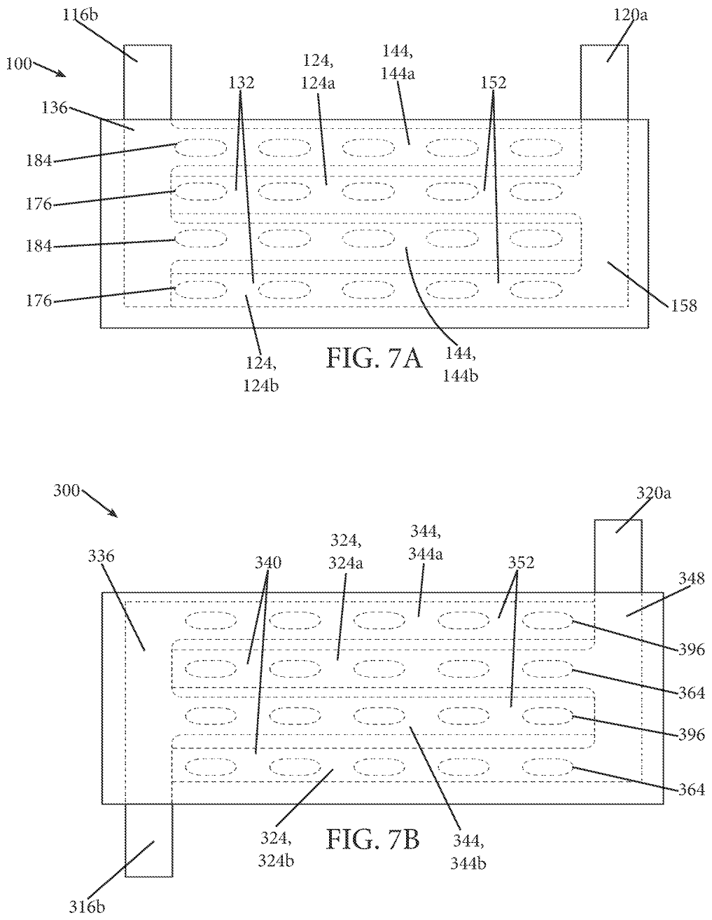

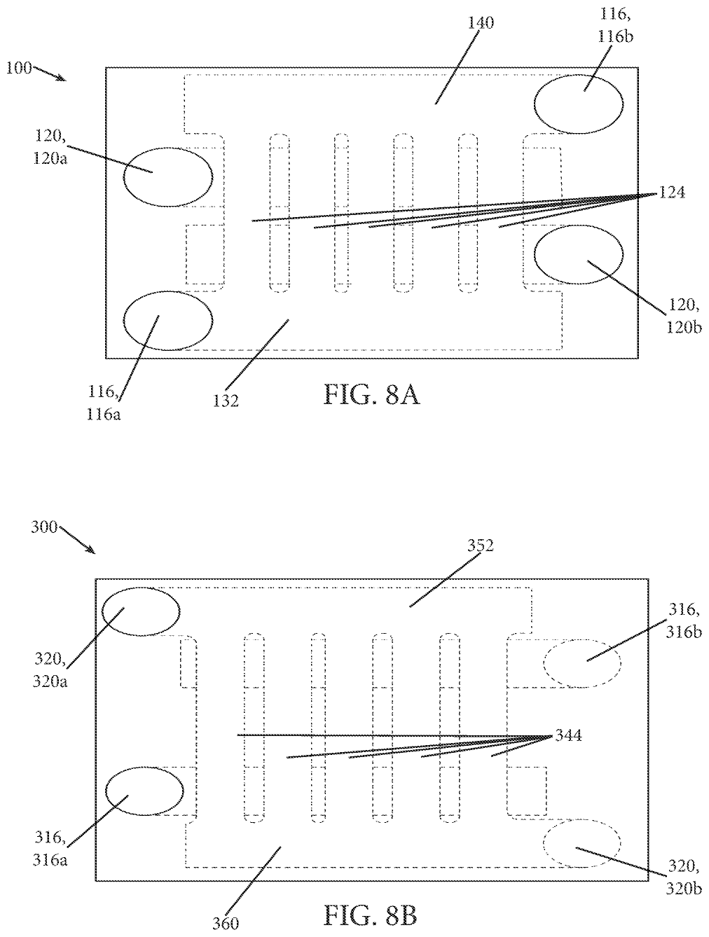

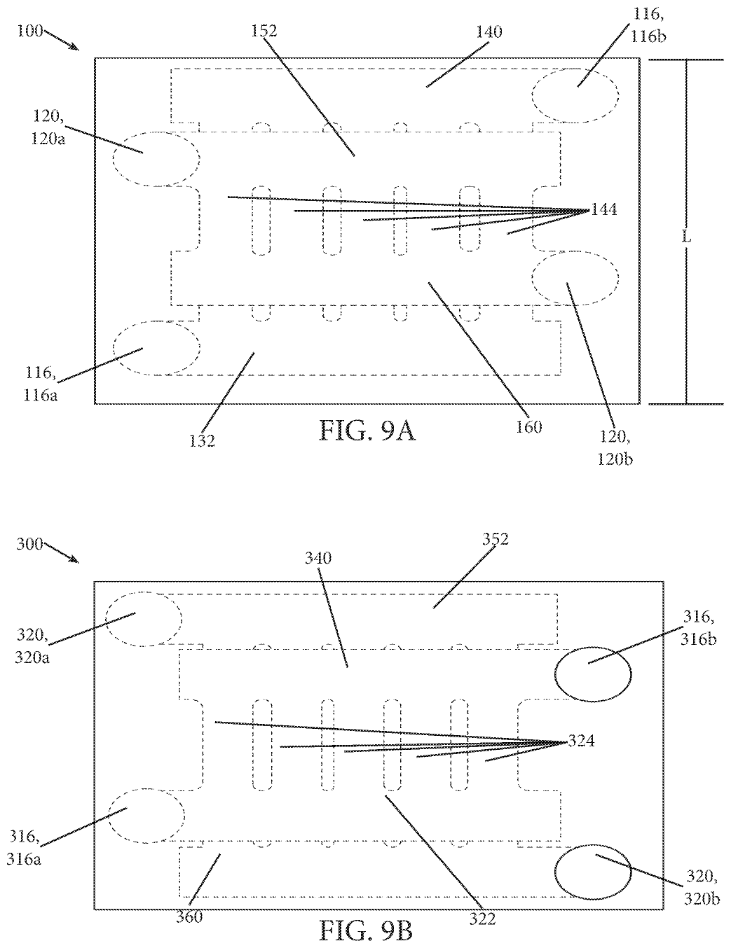

Turning now to FIGS. 4A-9B, which illustrate an example orientation of the first set of headers 116, 316, the second sets of headers 120, 320, the first set of channels 124, 324, and the second set of channels 144, 344 throughout the interior volume 112, 312 of the body 104, 304. In particular, FIG. 4A illustrates a transparent view of the second side 104d the heat exchanger 100 of FIG. 1A, FIG. 5A illustrates a transparent view of the fourth side 104f of the heat exchanger 100 of FIG. 1A, FIG. 6A illustrates a transparent view of the first side 104c of the heat exchanger 100 of FIG. 1A, FIG. 7A illustrates a transparent view of the third side 104e of the heat exchanger 100 of FIG. 1A, FIG. 8A illustrates a transparent view of the top side 104a of the heat exchanger 100 of FIG. 1A, and FIG. 9A illustrates a transparent view of the bottom side 104b of the heat exchanger 100 illustrated in FIG. 1A. As best illustrated in FIGS. 4A and 5A, the first set of channels 124 extends through the body 104 and each channel in the first set of channels 124 includes a first inlet aperture 164, a first inlet portion 168, a first outlet portion 172, a first outlet aperture 176, and a first conduit 180 extending between the first inlet portion 168 and the first outlet portion 172. Similarly, the second set of channels 144 extends through the body 104 and each channel in the second set of channels 144 includes a second inlet aperture 184, a second inlet portion 188, a second outlet portion 192, a second outlet aperture 196, and a second conduit 200 extending between the second inlet portion 188 and the second outlet portion 192.

In operation, the heat exchanger 100 receives the first and second fluids, both of which are received at high temperatures and pressures. As a result, the internal geometries of the first set of channels 124 and the second set of channels 144, as well as the first and second sets of headers 116, 120, should be able to withstand the high pressure and high temperature at which the first and second fluids enter the first and second sets of channels 124, 144. For example, the shape of the first set of channels 124 can be generally rectangular having a flat mid-section and elliptical ends and the second set of channels 144 can be generally rectangular having a flat mid-section and elliptical ends. In another example, the shape of the first set of channels 124 can be generally elliptical and the second set of channels 144 can be generally rectangular having a flat mid-section and semi-elliptical ends. In any of the foregoing configurations, one of the first or second sets of channels 124, 144 can accommodate one fluid at approximately 200 bar while the other of the first or second sets of channels 124, 144 can accommodate another fluid at atmospheric pressure. So configured, the shape of the first set of channels 124 may have a first shape that accommodates the first fluid at approximately 200 bar and the shape of the second set of channels 144 may have a second shape, different from the first, that accommodates the second fluid at atmospheric pressure. Accordingly, the shape of the first set of channels 124 is adapted to maintain the stress in the ceramic material under an acceptable limit (e.g., 65 MPa) while receiving the first fluid at a high pressure, while the shape of the second sets of channels 144 is adapted to maintain the stress in the ceramic material under an acceptable limit (e.g., 65 MPa) while receiving the second fluid at a pressure lower than the first fluid.

In particular, as shown in the example heat exchanger 100 of FIGS. 4A and 5A the first and second channels 124, 144 can be formed without sharp edges, sharp corners, and/or sharp transitions. Instead, the first and second channels 124, 144 may be formed having rounded and smooth transitions. For example, the transition from the at least one first horizontal portion 132 of the first header 116a to the first inlet aperture 164 and first inlet portion 168 can be a rounded edge thereby providing a smooth transition as the first fluid passes from the at least one horizontal portion 132 of the first header 116a into the first set of channels 124. Accordingly, the first inlet aperture 164 and/or the first inlet portion 168 may have a generally rectangular shape having a flat mid-section and semi-elliptical ends, while the first conduit 180 may have a different shape. Similarly, the transition from the first outlet portion 172 and the first outlet aperture 176 to the at least one second horizontal portion 140 of the second header 116b may be a rounded edge thereby providing a smooth transition as the first fluid passes from the first set of channels 124 to the at least one second horizontal portion 140. Accordingly, the first outlet aperture 176 and/or the first outlet portion 172 may have a generally rectangular shape having a flat mid-section and semi-elliptical ends. While the transitions from the at least one first and second horizontal portions 132, 140 of the first and second headers 116a, 116b, respectively, are illustrated in FIGS. 4A and 5A as being symmetrical, in other examples, the transitions may be asymmetrical. For example, the transition from the at least one first horizontal portion 132 of the first header 116a to the first inlet aperture 164 and the first inlet portion 168 can have a first shape, or geometry, while the transition from the first outlet portion 172 and the first outlet aperture 176 to the at least one second horizontal portion 140 of the second header 116b can have a second shape, or geometry, that is different from the first shape.

Likewise, the transition from the at least one first horizontal portion 152 of the first header 120a in the second set of headers 120 to the second inlet aperture 184 and the second inlet portion 188 can be a rounded edge thereby providing a smooth transition as fluid passes from the at least one first horizontal portion 152 of the first header 120a into the second set of channels 144. Accordingly, the second inlet aperture 184 and/or the second inlet portion 188 may have a generally rectangular shape having a flat mid-section and semi-elliptical ends, while the second conduit 200 may have a different shape. Similarly, the transition from the second outlet portion 192 and the second outlet aperture 196 to the at least one second horizontal portion 160 of the second header 120b may be a rounded edge thereby providing a smooth transition from the second set of channels 144 into the at least one second horizontal portion 160. Accordingly, the second outlet aperture 196 and/or the second outlet portion 192 may have a generally rectangular shape having a flat mid-section and semi-elliptical ends. While the transitions from the at least one first and second horizontal portions 152, 160 of the first and second headers 120a, 120b, respectively, are illustrated in FIGS. 4A and 5A as being symmetrical, in other examples, the transitions may be asymmetrical. For example, the transition from the at least one first horizontal portion 152 of the first header 120a to the second inlet aperture 184 and the second inlet portion 188 can have a first shape while the transition from the second outlet portion 192 and the second outlet aperture 196 to the at least one second horizontal portion 160 of the second header 120 can have a second shape that is different from the first shape.

Furthermore, as illustrated in FIGS. 4A and 5A, each channel in the first set of channels 124 may have a uniform shape along a length of the channel. In particular, each channel in the first set of channels 124 includes the conduit 180 that extends between the first inlet portion 168 and the first outlet portion 172. Accordingly, the shape of the conduit 180 between the first inlet portion 168 and the first outlet portion 172 may be a uniform shape. In some examples, the first inlet aperture 164 and the first inlet portion 168 can have the same shape as the first outlet aperture 176 and the first outlet portion 172, respectively. Accordingly, the shape of each conduit 180 in the first set of channels 124 can be the same shape as the first inlet and outlet portions 168, 172 and can be a uniform shape along its entire length. In other examples, however, as discussed above, the first inlet aperture 164 and the first inlet portion 168 can have a shape that is different from the shape of the first outlet aperture 176 and the first outlet portion 172, respectively. In such an example, each conduit 180 in the first set of channels 124 can have a shape that is substantially similar to either the shape of the first inlet portion 168 or the shape of the first outlet portion 172. However, each conduit 180 in the first set of channels 124 can have a shape that is substantially similar to the shape of the first inlet portion 168 along a portion of the conduit 180 that is disposed proximate the first inlet portion 168 and can have a shape that is substantially similar to the shape of the first outlet portion 172 along a portion of the conduit 180 that is disposed proximate the first outlet portion 172. So configured, each conduit 180 in the first set of channels 124 may include a first portion having a shape that is substantially similar to the first inlet portion 168, a second portion having a shape that is substantially similar to the first outlet portion 172, and a transition portion extending between the first and second portions where the conduit 180 changes shape.

Similarly, each channel in the second set of channels 144 may have a uniform shape along a length of the channel. In particular, each channel in the second set of channels 144 includes the conduit 200 that extends between the second inlet portion 188 and the second outlet portion 192. Accordingly, the shape of the conduit 200 between the second inlet portion 188 and the second outlet portion 192 may be a uniform shape. In some examples, the second inlet aperture 184 and the second inlet portion 188 have the same shape as the second outlet aperture 196 and the second outlet portion 192, respectively. Accordingly, the shape of each conduit 200 in the second set of channels 144 can be the same shape as the second inlet and outlet portions 188, 192 and can be a uniform shape along its entire length. In other examples, however, as discussed above, the second inlet aperture 184 and the second inlet portion 188 can have a shape that is different from the shape of the second outlet aperture 196 and the second outlet portion 192. Accordingly, each conduit 200 in the second set of channels 144 can have a shape that is substantially similar to either the shape of the second inlet portion 188 or the shape of the second outlet portion 192. However, each conduit 200 in the second set of channels 144 can have a shape that is substantially similar to the shape of the second inlet portion 188 along a portion of the conduit 200 that is disposed proximate to the second inlet portion 188 and can have a shape that is substantially similar to the shape of the second outlet portion 192 along a portion of the conduit 200 that is disposed proximate to the second outlet portion 192. So configured, each conduit 200 in the second set of channels 144 may include a first portion having a shape that is substantially similar to the second inlet portion 188, a second portion having a shape that is substantially similar to the second outlet portion 192, and a transition portion extending between the first and second portions where the conduit 200 changes shape.

FIGS. 6A and 7A illustrate a transparent view of the first side 104c and the third side 104e, respectively, of the body 104 of the heat exchanger 100 of FIG. 1A. As briefly mentioned above, as the first fluid enters the first header 116a of the first set of headers 116, the fluid travels along the first vertical portion 128 of the first header 116a and then to the at least one first horizontal portion 132. The fluid begins to fill each horizontal portion in the at least one first horizontal portion 132 by traveling away from the first vertical portion 128. Depending on the positioning of each horizontal portion in the at least one first horizontal portion 132, certain horizontal portions may fill prior to others. In any event, the first fluid within the heat exchanger 100 will be evenly spread across each horizontal portion in the at least one first horizontal portion 132 as the first fluid continues to enter the heat exchanger 100. So configured, the first fluid begins to flow through each first inlet aperture 164, each first inlet portion 168, each first conduit 180, each first outlet portion 172, and each first outlet aperture 176 of the first set of channels 124 until the first fluid reaches each of the horizontal portions of the at least one second horizontal portion 140. Once the first fluid reaches each horizontal portion in the at least one second horizontal portion 140, the fluid travels up the second vertical portion 136. Accordingly, the first fluid enters the first header 116a of the first set of headers 116 illustrated in FIG. 6A and is exhausted out of the second header 116b in the first set of headers 116 illustrated in FIG. 7A.

The second fluid, on the other hand, enters the first header 120a (FIG. 7A) of the second set of headers 120 and travels down the first vertical portion 148 and into each horizontal portion of the at least one first horizontal portion 152 (FIG. 7A). The fluid begins to fill each first horizontal portion in the at least one first horizontal portion 152 by traveling away from the first vertical portion 148. Depending on the positioning of each horizontal portion in the at least one first horizontal portion 152, certain horizontal portions may fill prior to others. In any event, the second fluid within the heat exchanger 100 will be evenly spread across each horizontal portion in the at least one first horizontal portion 152 as the second fluid continues to enter the heat exchanger 100. So configured, the second fluid begins to flow through each second inlet aperture 184, each second inlet portion 188, each second conduit 200, each second outlet portion 192, and each second outlet aperture 196 of the second set of channels 144 until the second fluid reaches each of the horizontal portions of the at least one second horizontal portion 160. Once the second fluid reaches each horizontal portion in the at least one second horizontal portion 160, the fluid travels up the second vertical portion 156. Accordingly, the second fluid enters the first header 120a of the second set of headers 120 illustrated in FIG. 7A and is exhausted out of the second header 120b of the second set of headers 120 illustrated in FIG. 6A.

Furthermore, each channel in the first set of channels 124 and each channel in the second set of channels 144 may be arranged in a matrix throughout the body 104 of the heat exchanger 100. As illustrated in FIGS. 6A and 7A, each channel in the first set of channels 124 is arranged in parallel with every other channel in the first set of channels 124 such that a central axis of each channel is in parallel with a central axis of each other channel. In particular, the first set of channels 124 may include a first row of channels 124a and a second row of channels 124b that are positioned within the interior volume 112 of the body 104 such that each channel in the first row of channels 124a is in parallel with each channel in the second row of channels 124b.

Similarly, each channel in the second set of channels 144 is arranged in parallel with every other channel in the first set of channels 144. In particular, the second set of channels 144 may include a first row of channels 144a and a second row of channels 144b that are positioned within the interior volume 112 of the body 104 such that each channel in the first row of channels 144a is in parallel with each channel in the second row of channels 144b. Ultimately, the first and second sets of channels 124, 144 are interspersed between each other to form the matrix.

For example, as illustrated in FIGS. 6A and 7A, the first row of channels 144a of the second set of channels 144 can be disposed proximate the top surface 104a of the body 104 and the first row of channels 124a of the first set of channels 124 is disposed immediately there below. Disposed below the first row of channels 124a of the first set of channels 124 is the second row of channels 144b of the second set of channels 144. Finally, disposed below the second row of channels 144b of the second set of channels 144 and proximate to the bottom surface 104b of the body 104 is the second row of channels 124b of the first set of channels 124.

In yet other examples, the channels in the first set of channels 124 and the channels in the second set of channels 144 can be arranged in a matrix that lacks symmetry. So configured, the channels in the first set of channels 124 can be positioned so that each channel still extends between the at least one first horizontal portion 132 of the first header 116a and the at least one second horizontal portion 140 of the second header 116b. However, the channels in the first set of channels 124 can be positioned anywhere along a length of the at least one first horizontal portion 132 and the at least one second horizontal portion 140. Similarly, the channels of the second set of channels 144 can be positioned so that each channel still extends between the at least one first horizontal portion 152 of the first header 120a and the at least one second horizontal portion 160 of the second header 120b. However, the channels in the second set of channels 144 can be positioned anywhere along a length of the at least one first horizontal portion 152 and the at least one second horizontal portion 160.

Turning now to FIGS. 8A and 9A, which illustrate a top down view of the body 104 of the heat exchanger 100 of FIG. 1A and a bottom view of the body 104 of the heat exchanger 100 of FIG. 1A, respectively. As discussed above, the first set of fluid headers 116 are arranged through the interior volume 112 of the body 104 and extend from the top surface 104a of the body 104. Further, the first fluid enters the first header 116a of the first set of headers 116 and travels, as discussed extensively above, to the second header 116b of the first set of headers 116 that is disposed on a side opposite from the first header 116a. Similarly, the second fluid enters the first header 120a of the second set of headers 120 and travels, as discussed extensively above, to the second headers 120b of the second set of headers 120 that is disposed on a side opposite from the first headers 120a. So configured, the first fluid flows in a first direction and the second fluid flows in a second direction thereby creating a counter-flow heat exchanger.

Turning now to FIGS. 4B, 5B, 6B, 7B, 8B, and 9B, which illustrate various sides of the heat exchanger 300 of FIG. 1B. In particular, FIG. 4B illustrates a transparent view of the second side 304d the heat exchanger 200 of FIG. 1B, FIG. 5B illustrates a transparent view of the fourth side 304f of the heat exchanger 300 of FIG. 1B, FIG. 6B illustrates a transparent view of the first side 304c of the heat exchanger 300 of FIG. 1B, FIG. 7B illustrates a transparent view of the third side 304e of the heat exchanger 300 of FIG. 1B, FIG. 8B illustrates a transparent view of the top side 304a of the heat exchanger 300 of FIG. 1B, and FIG. 9B illustrates a transparent view of the bottom side 304b of the heat exchanger 300 illustrated in FIG. 1B. As best illustrated in FIGS. 4B and 5B, the first set of channels 324 extends through the body 304 and each channel in the first set of channels 324 includes a first inlet aperture 364, a first inlet portion 368, a first outlet portion 372, a first outlet aperture 376, and a first conduit 380 extending between the first inlet portion 368 and the first outlet portion 376. Similarly, the second set of channels 344 extends through the body 304 and each channel in the second set of channels 344 includes a second inlet aperture 384, a second inlet portion 388, a second outlet portion 392, a second outlet aperture 396, and a second conduit 400 extending between the second inlet portion 388 and the second outlet portion 392.

In operation, the heat exchanger 300 receives the first and second fluids, both of which are received at high temperatures and pressures. As a result, the internal geometries of the first set of channels 324 and the second set of channels 344 should be able to withstand the high pressure at which the first and second fluids enter the first and second sets of channels 324, 344. In particular, as shown in the example of FIGS. 4B and 5B the first and second channels 324, 344 can be formed without sharp edges, sharp corners, and/or sharp transitions. Instead, the first and second channels 324, 344 may be formed having rounded and smooth transitions. For example, the transition from the at least one first horizontal portion 332 of the first header 316a to the first inlet aperture 364 and first inlet portion 368 can be a rounded surface thereby providing a smooth transition from the at least one first horizontal portion 332 to the first set of channels 324. Accordingly, the first inlet aperture 364 and/or the first inlet portion 368 may have a generally rectangular shape having a flat mid-section and semi-elliptical ends, while the first conduit 380 may have a different shape. Similarly, the transition from the first outlet portion 372 and the first outlet aperture 376 to the at least one second horizontal portion 340 of the second header 316b may be a rounded surface thereby providing a smooth transition from the first set of channels 324 to the at least one second horizontal portion 340. Accordingly, the first outlet aperture 376 and/or the first outlet portion 372 may have a generally rectangular shape having a flat mid-section and semi-elliptical ends. While the transitions from the at least one first and second horizontal portions 332, 340 of the first and second headers 316a, 316b, respectively, are illustrated in FIGS. 4B and 5B as being symmetrical, in other examples, the transitions need not be similar or symmetrical. For example, the transition from the at least one first horizontal portion 332 of the first header 316a to the first inlet aperture 364 and the first inlet portion 368 can have a first shape while the transition from first outlet portion 372 and the first outlet aperture 376 to the at least one second horizontal portion 340 of the second header 316b can have a second shape that is different from the first shape, or geometry.

Likewise, the transition from the at least one first horizontal portion 352 of the first header 320a in the second set of headers 320 to the second inlet aperture 384 and the second inlet portion 388 can be a rounded surface thereby providing a smooth transition from the at least one first horizontal portion 352 of the first header 320a to the second set of channels 344. Accordingly, the second inlet aperture 384 and/or the second inlet portion 388 may have a generally rectangular shape having a flat mid-section and semi-elliptical ends, while the second conduit 400 may have a different shape. Similarly, the transition from the second outlet portion 392 and the second outlet aperture 396 to the at least one second horizontal portion 360 of the second header 320b may be a rounded surface thereby providing a smooth transition from the second set of channels 344 to the at least one second horizontal portion 360. Accordingly, the second outlet aperture 196 and/or the second outlet portion 192 may have a generally rectangular shape having a flat mid-section and semi-elliptical ends. While the transitions from the at least one first and second horizontal portions 352, 360 of the first and second headers 320a, 320b, respectively, are illustrated in FIGS. 4B and 5B as being symmetrical, in other examples, the transitions need not be similar or symmetrical. For example, the transition from the at least one first horizontal portion 352 of the first header 320a to the second inlet aperture 384 and the second inlet portion 388 can have a first shape while the transition from the second outlet portion 392 and the second outlet aperture 396 to the at least one second horizontal portion 360 of the second header 320b can have a second shape that is different from the first shape, or geometry.

Furthermore, as illustrated in FIGS. 4B and 5B, each channel in the first set of channels 324 may have a uniform shape along a length of the channel. In particular, each channel in the first set of channels 324 includes the conduit 380 extending between the first inlet portion 368 and the first outlet portion 372. Accordingly, the shape of the conduit 380 between the first inlet portion 368 and the first outlet portion 372 may be a uniform shape. In some examples, the first inlet aperture 364 and the first inlet portion 368 have the same shape as the first outlet aperture 376 and the first outlet portion 372, respectively. Accordingly, the shape of each conduit 380 in the first set of channels 324 can be the same shape as the first inlet and outlet portions 368, 372 and can be a uniform shape along its entire length. In other examples, however, as discussed above, the first inlet aperture 364 and the first inlet portion 368 can have a shape that is different from the shape of the first outlet aperture 376 and the first outlet portion 372. In such an example, each conduit 380 in the first set of channels 324 can have a shape that is substantially similar to either the first inlet portion 368 or the first outlet portion 372. However, each conduit 380 in the first set of channels 324 can have a shape that is substantially similar to the shape of the first inlet portion 368 along a portion of the conduit 380 that is disposed proximate to the first inlet portion 368 and can have a shape that is substantially similar to the shape of the first outlet portion 372 along a portion of the conduit 380 that is disposed proximate to the first outlet portion 372. So configured, each conduit 380 in the first set of channels 324 may include a first portion having a shape that is substantially similar to the first inlet portion 368, a second portion having a shape that is substantially similar to the first outlet portion 372, and a transition portion extending between the first portion and the second portion where the conduit 380 changes shape.

Similarly, each channel in the second set of channels 344 may have a uniform shape along a length of the channel. In particular, each channel in the second set of channels 344 includes a conduit 400 that extends between the second inlet portion 388 and the second outlet portion 392. Accordingly, the shape of the conduit 400 between the second inlet portion 388 and the second outlet portion 392 may be a uniform shape. In some examples, the second inlet aperture 384 and the second inlet portion 388 have the same shape as the second outlet aperture 396 and the second outlet portion 392, respectively. Accordingly, the shape of each conduit 400 in the second set of channels 344 can be the same shape as the second inlet and outlet portions 388, 392 and can be a uniform shape along its entire length. In other examples, however, as discussed above, the second inlet aperture 384 and the second inlet portion 388 can have a shape that is different from the shape of the second outlet aperture 396 and the second outlet portion 392. Accordingly, each conduit 400 in the second set of channels 344 can have a shape that is substantially similar to either the second inlet portion 388 or the second outlet portion 392. However, each conduit 400 in the second set of channels 344 can have a shape that is substantially similar to the shape of the second inlet portion 388 along a portion of the conduit 400 that is disposed proximate to the second inlet portion 388 and can have a shape that is substantially similar to the shape of the second outlet portion 392 along a portion of the conduit 400 that is disposed proximate to the second outlet portion 392. So configured, each conduit 400 in the second set of channels 344 may include a first portion having a shape that is substantially similar to the second inlet portion 388, a second portion having a shape that is substantially similar to the second outlet portion 392, and a transition portion extending between the first and second portions where the conduit 400 changes shape.

FIGS. 6B and 7B illustrate a transparent view of the first side 304c and the third side 304e, respectively, of the body 104 of the heat exchanger 300 of FIG. 1B. As briefly mentioned above, as the first fluid enters the first header 316a of the first set of headers 316, the fluid travels along the first vertical portion 328 of the first header 316a and then to the at least one first horizontal portion 332. The fluid begins to fill each horizontal portion in the at least one first horizontal portion 332 by traveling away from the first vertical portion 328. Depending on the positioning of each horizontal portion in the at least one first horizontal portion 332, certain horizontal portions may fill prior to others. In any event, the first fluid within the heat exchanger 300 will be evenly spread across each horizontal portion in the at least one first horizontal portion 332 as the first fluid continues to enter the heat exchanger 300. So configured, the first fluid begins to flow through each first inlet aperture 364, each first inlet portion 368, each first conduit 380, each first outlet portion 372, and each first outlet aperture 376 of the first set of channels 324 until the first fluid reaches each of the horizontal portions of the at least one second horizontal portion 340. Once the first fluid reaches each horizontal portion in the at least one second horizontal portion 340, the fluid travels down the second vertical portion 336. Accordingly, the first fluid enters the first header 316a of the first set of headers 316 illustrated in FIG. 6B and is exhausted out of the second header 316b in the first set of headers 316 illustrated in FIG. 7B.

The second fluid, on the other hand, enters the first header 320a (FIG. 7B) of the second set of headers 320 and travels down the first vertical portion 348 and into each horizontal portion of the at least one first horizontal portion 352 (FIG. 7B). The fluid begins to fill each horizontal portion in the at least one first horizontal portion 352 by traveling away from the first vertical portion 348. Depending on the positioning of each horizontal portion in the at least one first horizontal portion 352, certain horizontal portions may fill prior to others. In any event, the second fluid within the heat exchanger 300 will be evenly spread across each horizontal portion in the at least one first horizontal portion 352 as the second fluid continues to enter the heat exchanger 300. So configured, the second fluid begins to flow through each second inlet aperture 84, each second inlet portion 388, each second conduit 400, each second outlet portion 392, and each second outlet aperture 396 of the second set of channels 344 until the second fluid reaches each horizontal portion of the at least one second horizontal portion 360. Once the second fluid reaches each horizontal portion in the at least one second horizontal portion 360, the fluid travels down the second vertical portion 356. Accordingly, the second fluid enters the first header 320a of the second set of headers 320 illustrated in FIG. 7B and is exhausted out of the second header 320b of the second set of headers 320 illustrated in FIG. 6B.

Furthermore, each channel in the first set of channels 324 and each channel in the second set of channels 344 may be arranged in a matrix throughout the body 304 of the heat exchanger 300. As illustrated in FIGS. 6B and 7B, each channel in the first set of channels 324 is arranged in parallel with every other channel in the first set of channels 324 such that a central axis of each channel is in parallel with a central axis of each other channel. In particular, the first set of channels 324 may include a first row of channels 324a and a second row of channels 334b that are positioned within the interior volume 312 of the body 304 such that each channel in the first row of channels 324a is in parallel with each channel in the second row of channels 324b.

Similarly, each channel in the second set of channels 344 is arranged in parallel with every other channel in the first set of channels 344. In particular, the second set of channels 344 may include a first row of channels 344a and a second row of channels 344b that are positioned within the interior volume 312 of the body 304 such that each channel in the first row of channels 344a is in parallel with each channel in the second row of channels 344b. Ultimately, the first and second sets of channels 324, 344 are interspersed between each other to form the matrix.

For example, as illustrated in FIGS. 6B and 7B, the first row of channels 344a of the second set of channels 344 can be disposed proximate the top surface 304a of the body 304 and the first row of channels 324a of the first set of channels 324 is disposed immediately there below. Disposed below the first row of channels 324a of the first set of channels 324 is the second row of channels 344b of the second set of channels 344. Finally, disposed below the second row of channels 344b of the second set of channels 344 and proximate to the bottom surface 304b of the body 304 is the second row of channels 324b of the first set of channels 324.

In yet other examples, the channels in the first set of channels 324 and the channels in the second set of channels 344 can be arranged in a matrix that lacks symmetry. So configured, the channels in the first set of channels 324 can be positioned so that each channel still extends between the at least one first horizontal portion 332 of the first header 316a and the at least one second horizontal portion 340 of the second header 316b. However, the channels in the first set of channels 324 can be positioned anywhere along a length of the at least one first horizontal portion 332 and the at least one second horizontal portion 340. Similarly, the channels of the second set of channels 344 can be positioned so that each channel still extends between the at least one first horizontal portion 352 of the first header 320a and the at least one second horizontal portion 360 of the second header 320b. However, the channels in the second set of channels 344 can be positioned anywhere along a length of the at least one first horizontal portion 352 and the at least one second horizontal portion 360.

Turning now to FIGS. 8B and 9B, which illustrate a top down view of the body 304 of the heat exchanger 300 of FIG. 1B and a bottom view of the body 304 of the heat exchanger 300 of FIG. 1B, respectively. As discussed above, the first set of fluid headers 316 are arranged through the interior volume 312 of the body 304 and extend from the top surface 304a of the body 304. Further, the first fluid enters the first header 316a of the first set of headers 316 and travels, as discussed extensively above, to the second header 316b of the first set of headers 316 that is disposed on a side opposite from the first header 316a. Similarly, the second fluid enters the first header 320a of the second set of headers 320 and travels, as discussed extensively above, to the second headers 320b of the second set of headers 320 that is disposed on a side opposite from the first headers 320a. So configured, the first fluid flows in a first direction and the second fluid flows in a second direction thereby creating a counter-flow heat exchanger.

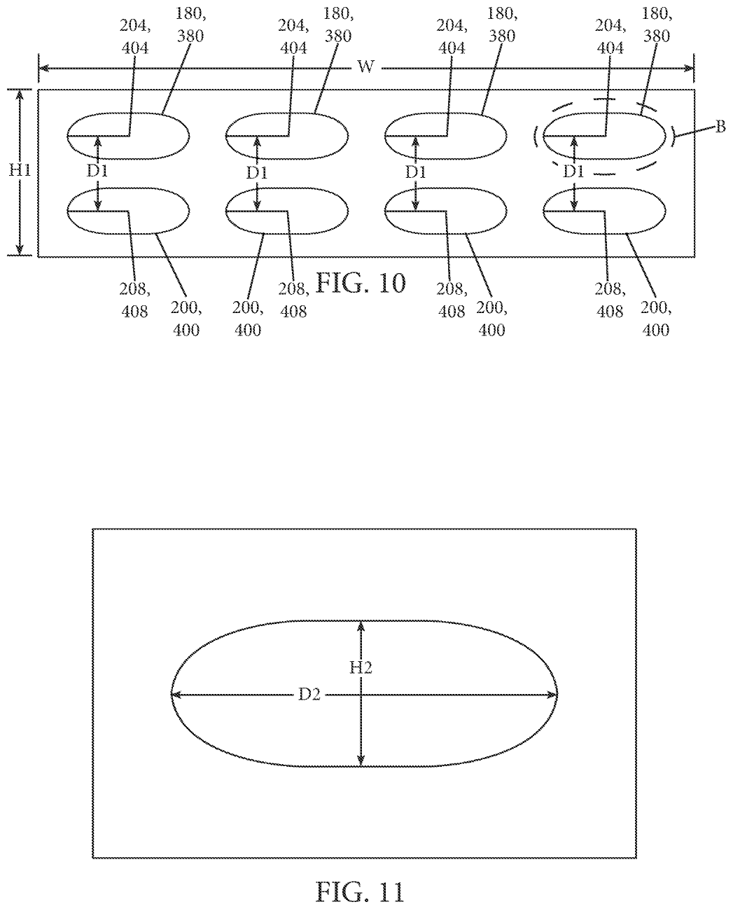

As discussed briefly above, the heat exchanger 100, 300 receives the first and second fluids at high temperatures (e.g., greater than or equal to 300° C., greater than or equal to 400° C., greater than or equal to 500° C., greater than or equal to 600° C., greater than or equal to 700° C., greater than or equal to 800° C., greater than or equal to 900° C., greater than or equal to 1000° C., etc.) and pressures (e.g., greater than or equal to 100 bar, greater than or equal to 200 bar, greater than or equal to 300 bar, greater than or equal to 400 bar, greater than or equal to 500 bar, greater than or equal to 600 bar, greater than or equal to 700 bar, etc.). As a result, interior surfaces of the heat exchanger 100, 300, and, in particular, the surfaces of the first and second sets of channels 124, 324, 144, 344 are exposed to high pressures exerted by the first and/or second fluids. Accordingly, the layout and design of the first and second sets of channels 124, 324, 144, 344 accommodate the high pressures exerted by the first and second fluids on the interior surfaces of the channels in the first and second sets of channels 124, 324, 144, 344. For example, channels, or other fluid passageways, that include sharp edges, corners, or turns can be more susceptible to high stresses at the sharp edges, corners or turns. Therefore, the first and second sets of channels 124, 324, 144, 344 include conduits 180, 200, 380, 400 having a generally rectangular shape with rounded, or elliptical edges, as shown in FIGS. 10 and 11.

In particular, the example conduit 180, 200, 380, 400 has a generally rectangular shape where an upper central surface and a lower central surface remain substantially parallel to one another and are generally flat, i.e., lacking roundness. The corners of each conduit 180, 200, 380, 400 are rounded, which can minimize the intensity of the stresses experienced by each conduit 180, 200, 380, 400 thereby allowing each conduit 180, 200, 380, 400 to withstand a relative high pressure exerted by the first or second fluid. Similarly, the transition from any of the at least one first horizontal portions 132, 332, 152, 352 or the at least one second horizontal portions 140, 340, 160, 360 to each conduit 180, 200, 380, 400 may include a smooth, or rounded, transition thereby eliminating sharp edges, corners, and turns within the heat exchanger 100, 300.

Continuing with FIGS. 10 and 11, the body 104, 304 generally includes a length of on the order of one (1) meter. Further, as illustrated in FIG. 10, a center 204, 404 of each channel in the first set of channels 124, 324 is spaced from a center 208, 408 of each channel in the second set of channels 144, 344. In particular, the center 204, 404 of each channel in the first set of channels 124, 324 is spaced from the center 208, 408 of each channel in the second set of channels 144, 344 by a distance D1 of 7.2 or less millimeters (“mm”). In other examples, the center 204, 404 of each channel in the first set of channels 124, 324 is spaced from the center 208, 408 of each channel in the second set of channels 144, 344 by a distance of approximately five (5) to ten (10) mm, one (1) to ten (10) mm, one (1) to twenty (20) mm, ten (10) to twenty (20) mm, or thirteen (13) to twenty five (25) mm. In certain examples, however, the center 204, 404 of each channel in the first set of channels 124, 324 is spaced from the center 208, 408 of each channel in the second set of channels 144, 344 by a distance D1 of approximately 5.0 mm, 5.1 mm, 5.2 mm, 5.3 mm, 5.4 mm, 5.5 mm, 5.6 mm, 5.7 mm, 5.8 mm, 5.9 mm, 6.0 mm, 6.1 mm, 6.2 mm, 6.3 mm, 6.4 mm, 6.5 mm, 6.6 mm, 6.7 mm, 6.8 mm, 6.9 mm, 7.0 mm, 7.1 mm, 7.2 mm, 7.3 mm, 7.4 mm, 7.5 mm, 7.6 mm, 7.7 mm, 7.8 mm, 7.9 mm, 8.0 mm, 8.1 mm, 8.2 mm, 8.3 mm, 8.4 mm, 8.5 mm, 8.6 mm, 8.7 mm, 8.8 mm, 8.9 mm, 9 mm, 9.1 mm, 9.2 mm, 9.3 mm, 9.4 mm, 9.5 mm, 9.6 mm, 9.7 mm, 9.8 mm, 9.9 mm. In yet other examples, the center 204, 404 of each channel in the first set of channels 124, 324 is spaced from the center 208, 408 of each channel in the second set of channels 144, 344 by a distance D1 of approximately one (1) to four (4) mm. In further examples, the center 204, 404 of each channel in the first set of channels 124, 324 is spaced from the center 208, 408 of each channel in the second set of channels 144, 344 by a distance D1 of approximately eleven (11) to twenty (20) mm.

Further, the dimensions of individual channels in the first or second sets of channels 124, 324, 144, 344 may vary depending on the overall width W (FIG. 10) and height H1 (FIG. 10) of the body 104, 304. For example, each conduit 180, 200, 380, 400 in the first and second sets of channels 124, 324, 144, 344 of a heat exchanger 100, 300 having a length L (FIG. 9A) of one (1) meter can have a diameter D2 (FIG. 11) of approximately one (1) to twenty (20) mm and a height H2 (FIG. 11) of approximately one (1) to twenty (20) mm. In certain examples, the diameter D2 (FIG. 11) can be greater than or equal to five (5) mm and the height H2 (FIG. 11) can be greater than or equal to two (2) mm. In some examples, the diameter D2 (FIG. 11) can be approximately ten (10) mm and the height H2 (FIG. 11) can be approximately two (2) to six (6) mm. In yet other examples, the diameter D2 (FIG. 11) can be approximately seven (7) mm and the height H2 (FIG. 11) can be approximately two (2) mm.

While the aforementioned heat exchanger module 100, 300 has been described herein as having a length on the order of one (1) meter, the length of the heat exchanger module 100, 300 is not intended to be so limited. For example, the overall dimensions of the heat exchanger modules 100, 300 may be larger than 1 meter, according to the capabilities of the relevant additive manufacturing processes/devices, as well as the size of the installation site of the heat exchanger module. In particular, certain materials are better suited for accommodating high temperature, high pressure, and corrosive fluids (e.g., ceramic materials). However, additively manufacturing a heat exchanger using such materials may be costly thereby limiting the size and complexity of the heat exchanger. Accordingly, the dimensions of an additively manufactured heat exchanger may be greater than one (1) meter in some embodiments.

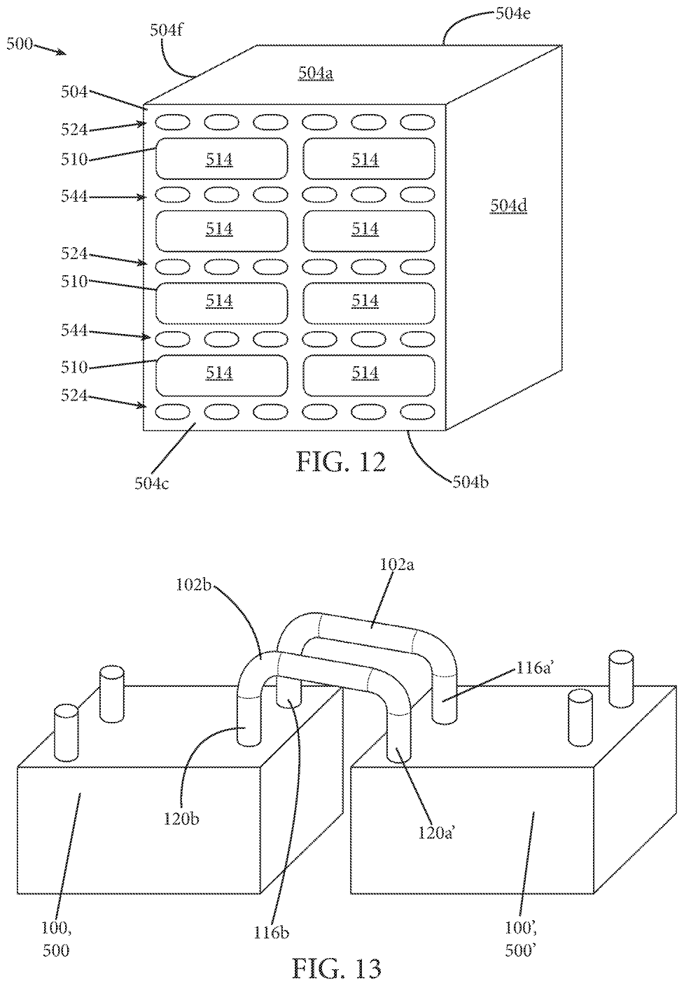

FIG. 12 illustrates a third example heat exchanger 500 that is constructed in accordance with the teachings of the present disclosure. The heat exchanger 500 of FIG. 12 is similar to the heat exchanger 100 of FIG. 1A and the heat exchanger 300 of FIG. 1B, except for the heat exchanger 500 of FIG. 12 includes a thermal storage material disposed within the interior volume 512 of the body 504. Thus, for ease of reference, and to the extent possible, the same or similar components of the heat exchanger 500 will retain the same reference numbers as outlined above with respect to the heat exchanger 100 of FIG. 1A and the heat exchanger 300 of FIG. 1B, although the reference numbers will be increased by 400 and 200, respectively.

Certain heat exchangers during their operation rely on a constant source of energy (e.g., the sun, radiant heat, burning coal, etc.) to heat a liquid which then could be used as a source of heat to boil a liquid thereby creating a vapor, or used to increase the temperature of another gas, either of which would propel a turbine generator and generate electricity. For example, a CSP electric plant typically utilizes a HTF to transfer heat from a solar field to a fluid disposed within a power block of a heat exchanger. However, on a cloudy day, it is possible that there is no sunlight that reflects off the solar field and into a tower or, alternatively, the sunlight is not strong enough to raise the temperature of the HTF to temperature necessary to ensure efficient heat transfer and, ultimately, efficient power generation. Thus, to compensate for cloudy days, or when the HTF needs to increase in temperature, the heat exchanger 500 includes a thermal storage material 514 to retain and provide heat when the temperature of the HTF is not at the required temperature.

More broadly, however, the foregoing thermal buffering feature is inherent in the design of the heat exchanger module 500 (or the heat exchanger modules 100, 300). For example, if, for a short period of time, the solar field supplies less energy than required by a turbine, then additional energy may be supplied by the thermal storage material 514, which will decrease the amount of energy stored in the thermal storage material 514. Most of the time, the heat exchanger module will operate where more solar energy is supplied than required by the turbine. Using heat from the thermal storage material for a short period of time, e.g., when clouds pass or remain over the solar field limiting the amount of sunlight that reaches the solar panels, is a buffering process beneficial to the turbine and overall plan efficiency. Using thermal energy stored in the thermal storage material 514 in this manner is referred to as the “thermal storage feature” of the heat exchanger module. So configured, CSP electric plants may generate electricity at night, when there is no energy being generated by the solar field, because of the thermal storage feature. However, CSP plants generally have thermal storage somewhere in the system, which may not include the thermal buffering feature that comes with placing the thermal storage material in the disclosed heat exchanger module. Accordingly, some examples of the disclosed heat exchanger module can have the thermal storage material 514 built-in.

The heat exchanger 500 of FIG. 12, like the heat exchanger 100 of FIG. 1A, includes a body 504 having a top side 504a, a bottom side 504b, a first side 504c, a second side 504d, a third side 504e, and a fourth side 504f. So configured, the top side 504a, the bottom side 504b, and the first, second, third, and fourth sides 504c-f form an outer surface 508 of the body 504 that surrounds an interior volume 512. However, unlike the heat exchanger 100 of FIG. 1A and the heat exchanger 300 of FIG. 1B, the heat exchanger 500 of FIG. 12 includes a set of storage channels 510 that are adapted to receive a thermal storage material 514.

Further, the heat exchanger 500 of FIG. 12 includes a first set of channels 524 integrally formed with and extending through the interior volume 512 of the body 504 and a second set of channels 544 that are integrally formed with and extending through the interior volume 512 of the body 504. However, unlike the heat exchangers 100, 300 of FIGS. 1A and 1B, the heat exchanger 500 of FIG. 12 includes a set of storage channels 510 that are integrally formed with and extend through the interior volume 512 of the body 504. The set of storage channels 510 may be disposed between the first and second sets of channels 524, 544, such that each storage channel in the set of storage channels 510 extends along the length of each channel in the first and second sets of channels 524, 544. Further, each storage channel in the set of storage channels 510 is adapted to receive the thermal storage material 514 capable of retaining and distributing heat received from the first and second fluids flowing through the first and second sets of channels 524, 544. Accordingly, the thermal storage material 514 may be any material capable of retaining and distributing heat. For example, the thermal storage material 514 can be a phase change material that remains partially, or completely, solid when cool and partially, or completely, liquid when warm.

While the above heat exchangers 100, 300, 500 have been discussed as single units, the disclosed heat exchanger can, advantageously, be coupled to at least one additional heat exchanger 100′, 300′, 500′. By coupling the heat exchanger 100, 300, 500, to at least one additional heat exchanger 100′, 300′, 500′, a modular heat exchanger may be formed thereby increasing the energy production and/or heat transfer capabilities of a system. FIGS. 13-15 illustrate various examples of how the heat exchanger 100, 300, 500 can be operably coupled to the at least one additional heat exchanger 100′, 300′, 500′.

In particular, FIG. 13 illustrates the heat exchanger 100, 500 operably coupled in series to the additional heat exchanger 100′, 500′. As illustrated, the second header 116b of the first set of headers 116 of the first heat exchanger 100, 500 is coupled to the first header 116a′ of the first set of headers 116′ of the additional heat exchanger 100′, 500′ via a first pipe 102a. Similarly the second header 120b of the second set of headers 120 of the first heat exchanger 100, 500 is coupled to the first header 120a′ of the second set of headers 120′ of the additional heat exchanger 100′, 500′ via a second pipe 102b. With the heat exchanger 100, 500 and the additional heat exchanger 100′, 500′ operably coupled in series, the effective length of the heat exchanger is increased thereby allowing for a greater transfer of energy over a longer length than the length of a single heat exchanger 100, 500.

FIG. 14 illustrates the heat exchanger 300 of FIG. 1B coupled in series to an additional heat exchanger 300′. As illustrated, the second header 316b of the first set of headers 316 of the first heat exchanger 300 is operably coupled to the first header 316a′ of the first set of headers 316′ of the additional heat exchanger 300′ via a first pipe 302a. Similarly, the second header 320b of the second set of headers 320 of the first heat exchanger 300 is coupled to the first header 320a′ of the second set of headers 320′ of the additional heat exchanger 300′. With the heat exchanger 300 and the additional heat exchanger 300′ operably coupled in series, the effective length of the heat exchanger is increased thereby allowing for a greater transfer of energy over a longer length than the length of a single heat exchanger 300. Further, as a result of the second header 316b of the first set of headers 316 and the second header 320b of the second set of headers 320 extending from the bottom side 304b of the heat exchanger 304, the heat exchangers 300, 300′ may be stacked vertically. Moreover, because of the orientation of the first and second set of headers 316, 320, the additional heat exchanger 300′ may be rotated at an angle of 180° relative to the first heat exchanger 300. Thus, as further heat exchangers are operatively coupled in series, each heat exchanger may be rotated at an angle of 180° relative to the heat exchanger disposed above or below. While not illustrated herein, a support may be disposed between the first heat exchanger 300 and the additional heat exchanger 300′ to eliminate excess bending forces exerted on the first and second pipes 302a, 302b by the heat exchanger 300. So configured, the structural stability of multiple stacked heat exchangers is thereby increased.

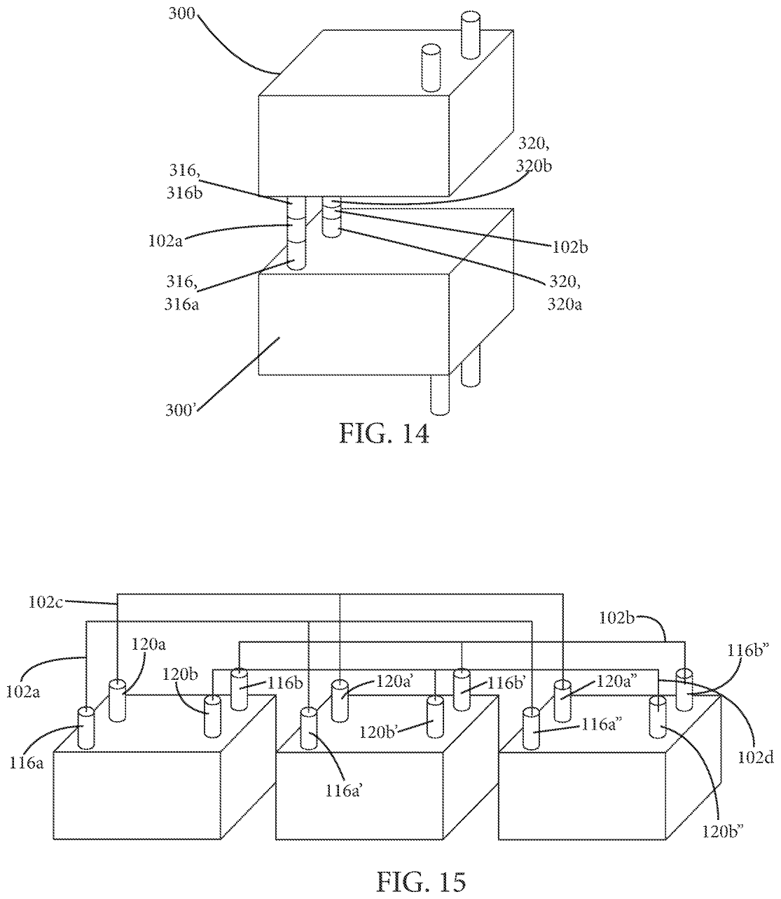

FIG. 15 illustrates the heat exchanger 100 operably coupled to additional heat exchangers 100′, 100″ in parallel. As illustrated, the heat exchanger 100 is operably coupled to a first additional heat exchanger 100′ and to a second additional heat exchanger 100″. Similarly, the first additional heat exchanger 100′ is operably coupled to both the heat exchanger 100 and the second additional heat exchanger 100″, and the second additional heat exchanger 100″ is operably coupled to both the heat exchanger 100 and the first additional heat exchanger 100′. In particular, the first header 116a of the first set of headers 116 of the heat exchanger 100, the first header 116a′ of the first set of headers 116′ of the first additional heat exchanger 100′, and the first header 116a″ of the first set of headers 116″ of the second additional heat exchanger 100″ are each operably coupled to one another via a first pipe 102a. The second header 116b of the first set of headers 116 of the heat exchanger 100, the second header 116b′ of the first set of headers 116′ of the first additional heat exchanger 100′, and the second header 116b″ of the first set of headers 116″ of the second additional heat exchanger 100″ are each operably coupled to one another via a second pipe 102b. Similarly, the first header 120a of the second set of headers 120 of the heat exchanger 100, the first header 120a′ of the second set of headers 120′ of the first additional heat exchanger 100′, and the first header 120a″ of the second set of headers 120″ of the second additional heat exchanger 100″ are each operably coupled to one another via a third pipe 102c. The second header 120b of the second set of headers 120 of the heat exchanger 100, the second header 120b′ of the second set of headers 120′ of the first additional heat exchanger 100′, and the second header 120b″ of the second set of headers 120″ of the second additional heat exchanger 100″ are each operably coupled to one another via a fourth pipe 102d. So configured each of the heat exchanger 100, the first additional heat exchanger 100′ and the second additional heat exchanger 100″ are operably coupled to one another in parallel.

While systems of heat exchangers illustrated in FIGS. 13-15 illustrate either an additional heat exchanger or two additional heat exchangers, the disclosed heat exchanger may be coupled to an infinite amount of additional heat exchangers. Accordingly, the disclosed heat exchanger is a heat exchanger module that allows for a modular heat exchanger to be created and either scaled up (i.e., additional heat exchanger modules are added) or scaled down (i.e., heat exchanger modules are removed) depending on the needs and requirements of the particular application of the heat exchanger module.

For example, a CSP electric plant must transfer approximately 100 to 300 megawatts (“MW”). In order to achieve such an energy transfer, a plurality of heat exchanger modules 100 may be operably coupled in parallel. In other examples, however, a plurality of heat exchanger modules 100 can be placed in series to achieve a higher heat transfer rate than a single heat exchanger module 100. In turn, several pluralities of heat exchanger modules 100 can be operably coupled in parallel, in series, or both, to achieve the required heat transfer rate of a particular CSP electric plant. Such a configuration may be repeated indefinitely until the appropriate heat transfer rate is obtained.

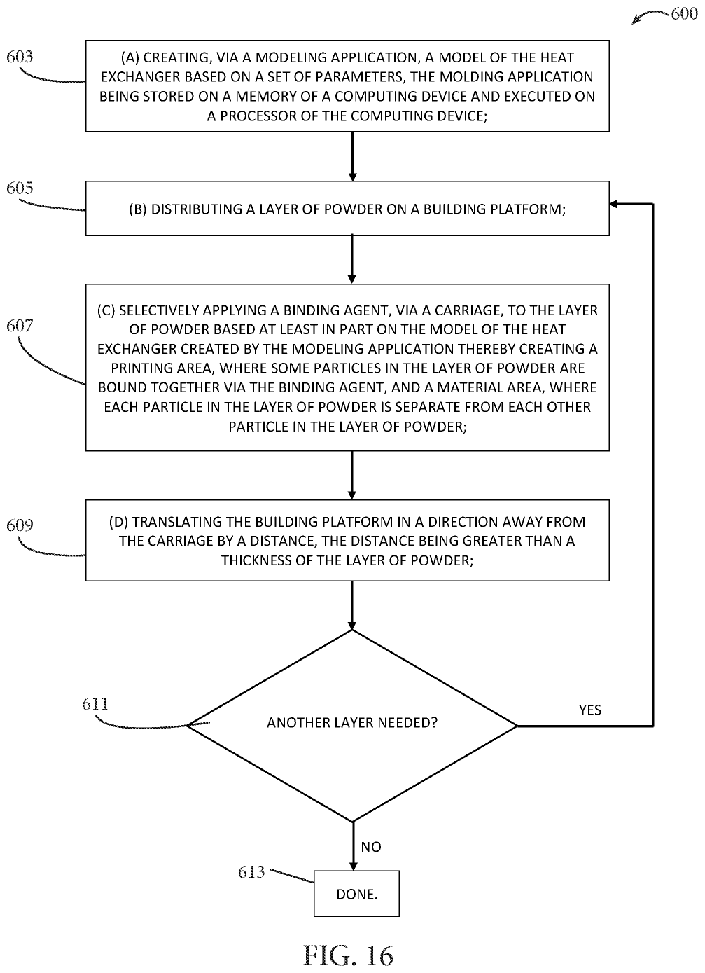

FIG. 16 is a diagram of an example of a method or process 600 of additively manufacturing a heat exchanger, according to the teachings of the present disclosure. The method 600 schematically illustrated in FIG. 16 is a method of custom manufacturing any heat exchanger disclosed herein. Specifically, the disclosed method 600 allows for the creation of a heat exchanger that, otherwise, would not be possible without additive manufacturing, could not be manufactured without very expensive costs, or could not retain the structural properties necessary for the particular application of the heat exchanger due to the complex shapes of the separate channels and openings. For example, attempting to create the disclosed heat exchanger using known technology can require the creation of many separate components that later need to be welded, or otherwise fixed, to one another. However, welding several components together creates multiple seams which can greatly diminish the structural integrity of the heat exchanger and add significant cost to manufacturing the heat exchanger.

More specifically, the method 600 includes creating a heat exchanger using an additive manufacturing technique, based on the given application. The additive manufacturing technique may be an additive manufacturing technique or process that builds three-dimensional objects by adding successive layers of material on a material already disposed on a base. The additive manufacturing technique may be performed by any suitable machine or combination of machines. The additive manufacturing technique may typically involve or use a computer, three-dimensional modeling software (e.g., Computer Aided Design (“CAD”) software), machine equipment, and layering material. Once a CAD model is produced, the machine equipment may read in data from the CAD file and layer or add successive layers of liquid, powder, sheet material (for example) in a layer-upon-layer fashion to fabricate a three-dimensional object. The additive manufacturing technique may include any of several techniques or processes, such as, for example, a stereolithography (“SLA”), a fused deposition modeling (“FDM”) process, multi-jet modeling (“MJM”) process, a selective laser sintering (“SLS”) process, an electronic beam additive manufacturing process, a binder jetting process, and an arc welding additive manufacturing process. In some examples, the additive manufacturing process may include a directed energy laser deposition process. Such a directed energy laser deposition process may be performed by a multi-axis computer-numerical-control (“CNC”) lathe with directed energy laser deposition capabilities.

Creating the disclosed heat exchanger(s) may be accomplished using any of the aforementioned additive manufacturing techniques. Accordingly, creation of the disclosed heat exchanger using the binder jetting technique will be discussed, as an example. Binder jetting generally involves applying a layer of powder evenly across the entirety of a building platform. Once applied, a carriage having a set of inkjets passes over the entirety of the layer of powder spread across the building platform selectively applying a binding agent based on what is being printed. The carriage may selectively apply the binding agent to the layer of powder based on the structure being printed, so that after the carriage passes over the building platform a printing area and a material area is formed on the building platform. The printing area being the section of the building platform where the carriage applies the binding agent thereby creating a first layer of the structure. In other words, in the printing area, some of the particles in the layer of powder are bound together via the binding agent. The material area being the area where the carriage did not apply a binding agent thereby leaving the layer of powder loose, such that each particle in the material area is separate from every other particle. Thereafter, the building platform translates in a direction away from the carriage (e.g., down, in the direction of gravity) creating enough space for another layer of powder to be laid down on the building platform. Accordingly, the building platform translates by a distance substantially equal to or greater than a thickness of a single layer of powder. This process is repeated until the structure is created.

Turning back to FIG. 16, the method 600 includes creating a model of the heat exchanger based on a set of parameters using a modeling application (block 603). The modeling application is stored in a memory of a computing device and is executed on a processor of the computing device. The computing device may be local or remote. Next, a first layer of powder is distributed to a building platform, as discussed above (block 605). The first layer acts as a base upon which the entire structure will be built. Once the first layer of powder is applied, the computing device determines where the carriage should create the printing area by selectively applying the binding agent to the first layer of powder, i.e., where the first layer of the structure should be placed (block 607). In determining where the carriage should create the printing area, the computing device determines whether the current layer requires any voids to be created. A void can be, for example, the first set of channels, the second set of channels, the first set of headers, or the second set of headers. After the carriage selectively applies the binding agent creating the printing area for the first layer, the building platform lowers by a distance substantially equal to or greater than a width of the layer of powder needed to be applied (block 609). Once lowered, another layer of powder is applied to the building platform. The carriage again selectively applies the binding agent to the additional layer of powder and creates a printing area for the additional layer of powder. Then the computing device determines whether an additional layer of powder is needed (block 611). If an additional layer of powder is needed, the process begins again by lowering the building plate and then applying another layer of powder. This process is repeated until successive layers have built the entire heat exchanger. In particular, as the printing area of each layer is selectively applied by the carriage, the heat exchanger is slowly created one layer at a time. The computing device determines where the printing area of each layer should be in order to successively build the heat exchanger thereby building, or printing, the body, the first set of channels, the second set of channels, the first set of headers, and the second set of headers simultaneous, at some points, so that each layer includes the correct amount of voids (e.g., fluid channels). Once the above process is repeated several times, and it is determined that an additional layer of powder is not needed, the process terminates and the heat exchanger has finished printing (block 613). The powder used by the 3D printer can be one or more suitable materials, such as, for example, ceramics, stainless steel, aluminum, various alloys, and by virtue of being customizable, can be any number of different shapes and/or sizes.

In forming each layer of powder, a thickness of the layer is determined based on the preciseness and tolerances needed for the particular part to be printed. If, for example, the heat exchanger requires high precision and has a narrow tolerance, then a smaller thickness is necessary. In such an example, the thickness of the layer of powder can be between 10-60 microns, 10-40 microns, 5-30 microns, 10-50 microns, 20-40 microns, etc. In other examples, however, where a high precision and a narrow tolerance is not required, the thickness of the layer of powder can be between 50-100 microns, 50-80 microns, 50-60 microns, 70-100 microns, 60-90 microns, etc.

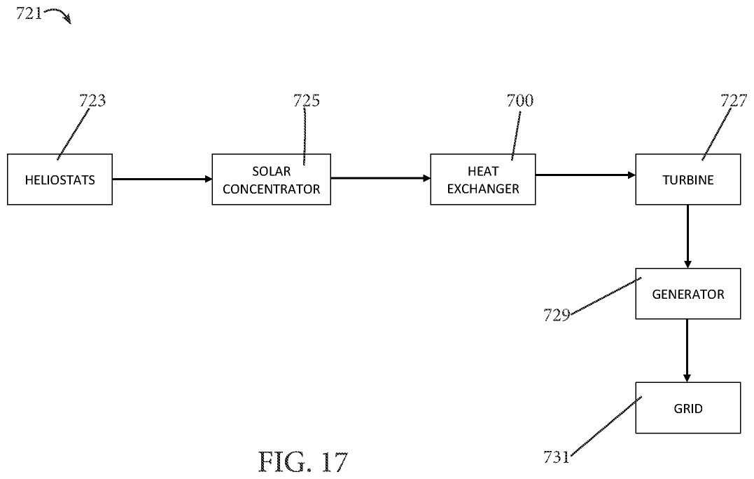

Turning now to FIG. 17, which illustrates a CSP electricity plant 721 having at least one of the disclosed heat exchangers 700. The CSP electricity plant 721 includes an array of heliostats 723 that receive and deflect sunlight toward a solar concentrator 725 (e.g., parabolic trough, dish, concentrating linear Fresnel reflector, and solar power tower) which contains the HTF. The HTF can be, for example, a molten salt which is heated and then sent to the at least one heat exchanger 700. In the heat exchanger 700, the HTF interacts with a working fluid such as, for example, super critical carbon dioxide. In particular, the HTF transfers thermal energy, or heat, to the working fluid, which then travels to a turbine 727. The working fluid spins the blades of the turbine 727 thereby turning a central shaft that is coupled to a generator 729. So configured, as the central shaft rotates, the generator 729 creates electricity which is then sent to the grid 731.

### Example

A small scale heat exchanger was constructed of a ceramic material using an additive manufacturing technique called “binder jetting” and a study was run on the heat exchanger using COMSOL Multiphysics software to optimize the size and shape of the channels disposed in and extending through the heat exchanger, which was a component in a Brayton power cycle. The heat exchanger constructed in this study had a height of one (1) meter, a length of one (1) meter, and a width of one (1) meter thereby giving the heat exchanger a volume of one meter cubed (1 m³). Accordingly, the heat exchanger had a flow length of one (1) meter and, in that distance, each fluid flowing through the heat exchanger must change approximately 200° C. in the context of a CSP electric plant. In the study, a molten salt was used as a liquid heat transfer fluid (hereinafter “HTF”) to transfer heat to a super critical carbon dioxide (hereinafter “the sCO₂”) used as a working fluid disposed within the heat exchanger.

In the study, the sCO₂ entered the heat exchanger at 540° C. and exited at 700° C. at a pressure of 200 bar and the molten salt HTF entered the heat exchanger at 750° C. and exited at 570° C. at approximately atmospheric pressure (hereinafter “the Inlet and Outlet Conditions”). The study assumed a maximum allowable pressure drop across the channel having the sCO₂ of 80 Pa. Using the Inlet and Outlet Conditions, the study analyzed the performance of both a heat exchanger having a cross-flow configuration and a heat exchanger having a counter-flow configuration.

The heat exchanger arranged in a cross-flow configuration showed that the Inlet and Outlet Conditions could be satisfied with channels extending through the heat exchanger that are 80 mm wide, 2.2 mm high, 1 m long, with 2 mm thick ceramic walls using a sCO₂ flow rate of 0.0014 kg/s per channel and a molten salt HTF flow rate of 0.0013 kg/s per channel. Both the channels containing the sCO₂ and channels containing the molten salt HTF were operating in the laminar flow regime. These parameters resulted in 254 W being transferred per set of channels and a sCO₂ pressure drop of 10.6 Pa. With these conditions, a 1 m³ heat exchanger would transfer 0.24 MW of heat, and a total of 419 parallel heat exchangers would be required for a 50 MW CSP electric plant.

On the other hand, the heat exchanger arranged in a counter-flow configuration using the Inlet and Outlet Conditions resulted in 951 W being transferred per set of channels and included a sCO₂ pressure drop of 28 Pa. In the counter-flow configuration study, the sCO₂ flow rate was 0.0056 kg/s per channel and the molten salt HTF flow rate was 0.0050 kg/s per channel. With a much greater heat transfer using the counter-flow configuration, the study then set out to optimize the channel configuration. In particular, the study set out to determine an efficient and practical channel geometry to handle the high pressures and temperatures at which the channels received the sCO₂ and the molten salt HTF.

To optimize the channel geometry, an elastic material model representing carborundum, also known as silicon carbide (“SiC”), was used with Multiphysics Object Oriented Simulation Environment (hereinafter “MOOSE”), an open source finite element code developed by Idaho National Laboratory, for structural calculations and Trelis for building finite element models of the channel cross-section. The material properties were: Young's Modulus of 300 GPa, Poisson's Ratio of 0.2, coefficient of thermal expansion of 4.5×10−6/° C., and tensile strength of 250 MPa. The pressures in the flow channels were 20 MPa for channels including the sCO₂ and 0.11 MPa for the channels including the molten salt HTF, and the maximum principle design stress was 65 MPa.

With these constrains, a rectangular flow channel having a width of 10 mm, a height of 2.2 mm, and a corner radius of 0.2 mm was tested first. The results of the test showed that the rectangular flow channel experienced a maximum stress of 207 MPa, which was well above the 65 MPa design limit. Further review of the test results showed that the highest stresses occurred at the corners of the rectangular flow channel. Accordingly, the stresses experienced at the corners of the rectangular flow channel needed to be mitigated. Further tests were conducted and a rectangular channel shape having semi-elliptical ends proved to be the best configuration to ensure the maximum stresses were below the 65 MPa design limit. In particular, the flow channel had a width of 10 mm and the semi-elliptical ends had a semi-major axis (“a”) equal to 4 mm and a semi-minor axis (“b”) equal to 2.1 mm. Flow channels having these dimensions are hereinafter referred to as “the Optimized Channel.”

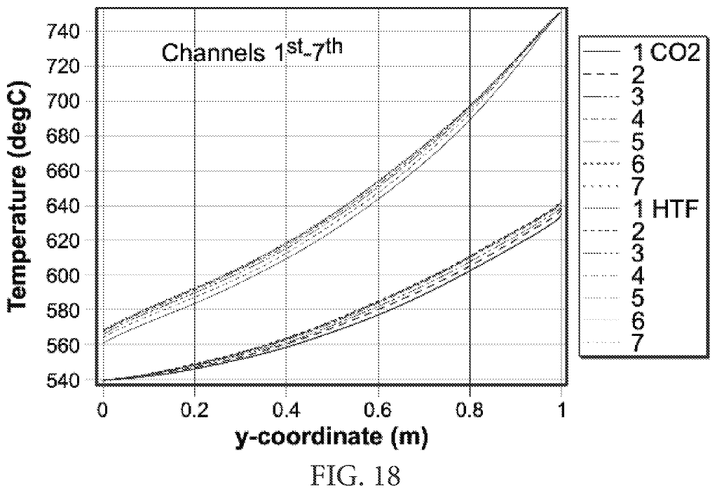

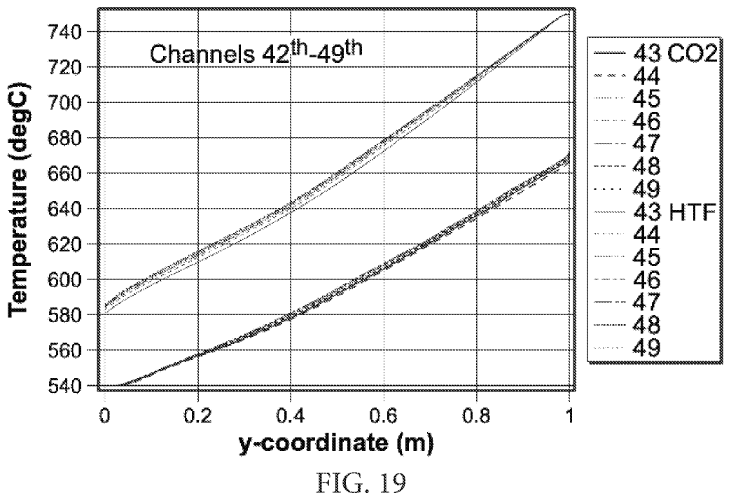

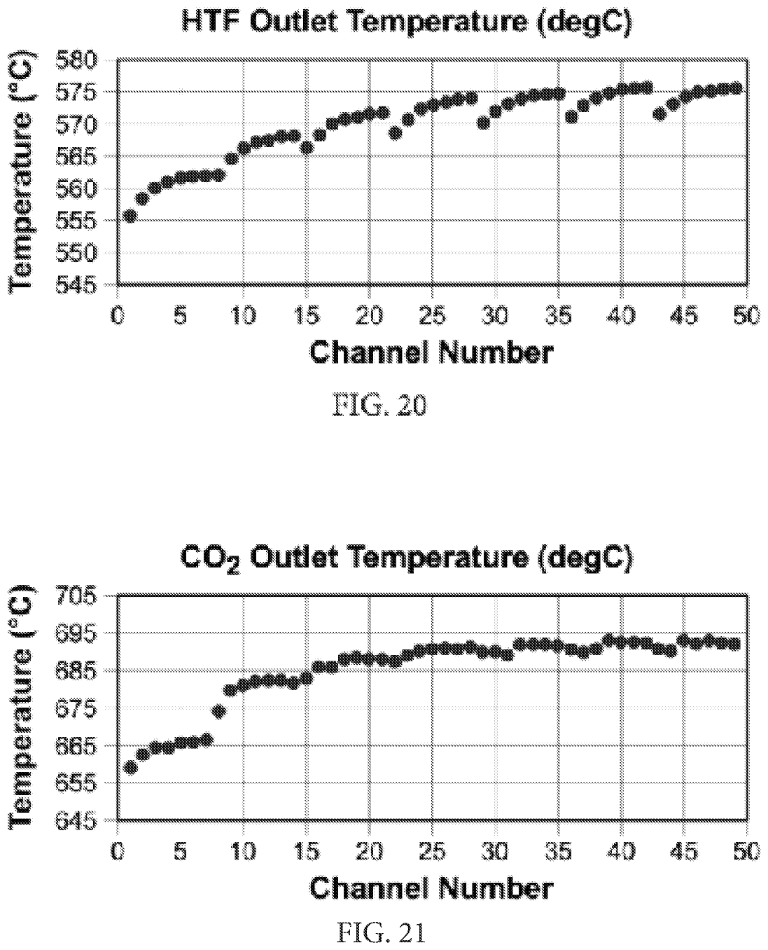

A second test of the heat exchanger was then conducted using the Optimized Channel design (hereinafter “the Second Test”). Using the Optimized Channel design, a section of the heat exchanger was analyzed using COMSOL Multiphysics. In the Second Test, a corner of a heat exchanger was simulated using rows and columns of flow channels. In particular, the model included seven (7) channels disposed in each row and thirteen and a half (13.5) channels disposed in each column, and each column was numbered 1-7 for purposes of analyzing the resulting data. FIGS. 18-21 depict the resulting data of the Second Test. In particular, FIGS. 18 and 19 shows the temperature profiles along a centerline of channels 1-7 and 42-49, respectively. FIGS. 20 and 21 show the average channel outlet temperatures for the channels containing the molten salt HTF and the average channel outlet temperatures for the channels containing the sCO₂. The Second Test showed that a heat exchanger with the Optimized Chanel design had a total heat transfer rate of 0.5 MW. Accordingly, a heat exchanger having a volume of 1 m³ using the Optimized Channel design results in a power density of 0.5 MW/m³.

The study then performed a parametric study to determine the magnitude of improvement that could be obtained. The parametric study found that the heat exchanger heat transfer was most sensitive to two parameters: (1) the thermal conductivity of the ceramic material and (2) the height of the fluid flow channels. As a baseline, a heat exchanger with flow channel having the Optimized Channel design resulted in a heat transfer rate of approximately 0.5 MW. Next, the channel height was modified with the thermal conductivity of the body of the heat exchanger being 5 W/mK. In particular, the channel height was changed from 4.2 mm to 3 mm, which more than doubled the heat transfer rate to a power density of greater than 1 MW/m³. The parametric study found that a maximum power density of 3.5 MW/m³ could be achieved with a 2 mm channel height and a ceramic thermal conductivity of 15 W/mK.

The following list of aspects reflects a variety of the embodiments explicitly contemplated by the present application. Those of ordinary skill in the art will readily appreciate that the aspects below are neither limiting of the embodiments disclosed herein, nor exhaustive of all the embodiments conceivable from the disclosure above, but are instead meant to be exemplary in nature.

1. A heat exchanger adapted to receive high temperature, high pressure, and corrosive fluids, the heat exchanger comprising: a body having an interior volume; a first set of channels extending through the body, each channel in the first set of channels having a first inlet aperture, a first inlet portion, a first outlet aperture, a first outlet portion, and a first conduit extending between the first inlet portion and the first outlet portion, the first conduit having a uniform shape along a length of the first conduit; a second set of channels extending through the body such that the second set of channels is spaced from the first set of channels by a distance, each channel in the second set of channels having a second inlet aperture, a second inlet portion, a second outlet aperture, a second outlet portion, and a second conduit extending between the second inlet portion and the second outlet portion, the second conduit having a uniform shape along a length of the second conduit; a first set of headers integrally formed with the body and in fluid communication with each channel in the first set of channels; and a second set of headers integrally formed with the body and in fluid communication with each channel in the second set of channels.

2. A heat exchanger according to aspect 1, further comprising a set of storage channels integrally formed with and extending through the body, each storage channel in the set of storage channels being adapted to receive a thermal storage material, the set of storage channels being disposed between the first set of channels and the second set of channels.

3. A heat exchanger according to aspects 1 or 2, wherein the first conduit includes a semi-elliptical cross-section along the length of the first conduit and the second conduit includes a semi-elliptical cross-section along the length of the second conduit.

4. A heat exchanger according to any one of aspects 1 to 3, wherein the first conduit has a height of approximately 2 to 6 millimeters and the second conduit has a height of approximately 2 to 6 millimeters.

5. A heat exchanger according to any one of aspects 1 to 4, wherein a shape of the first inlet portion and a shape of the first outlet portion are substantially similar to the shape of the first conduit, and a shape of the second inlet portion and a shape of the second outlet portion are substantially similar to the shape of the second conduit.

6. A heat exchanger according to any one of aspects 1 to 5, wherein the first set of channels is adapted to receive a first fluid having a temperature between 500° C. and 800° C., and the second set of channels is adapted to receive a second fluid having a temperature between 500° C. and 800° C., the first fluid being different from the second fluid.

7. A heat exchanger according to any one of aspects 1 to 6, wherein the second set of channels is adapted to receive a corrosive fluid and the body is a ceramic material.

8. A heat exchanger according to any one of aspects 1 to 7, wherein the first inlet portion has a first shape, the first outlet portion has a second shape, the second inlet portion has a third shape, and the second outlet portion has a fourth shape, the first and second shapes being different from the third and fourth shapes.

9. A heat exchanger according to any one of aspects 1 to 8, wherein each header in the first set of headers includes a first vertical portion and at least one first horizontal portion, each horizontal portion of the at least one first horizontal portion being in fluid communication with the first vertical portion; and wherein, each header in the second set of headers includes a second vertical portion and at least one second horizontal portion, each horizontal portion of the at least one second horizontal portion being in fluid communication with the second vertical portion.

10. A heat exchanger according to any one of aspects 1 to 9, wherein a header in the first set of headers is in fluid communication with the first inlet portion of each channel in the first set of channels and another header in the first set of headers is in fluid communication with the first outlet portion of each channel in the first set of channels.

11. A heat exchanger according to any one of aspects 1 to 10, wherein a header in the second set of headers is in fluid communication with the second inlet portion of each channel in the second set of channels and another header in the second set of headers is in fluid communication with the second outlet portion of each channel in the second set of channels.

12. A heat exchanger according to any one of aspects 1 to 11, wherein the first conduit of each channel in the first set of channels is substantially linear and the second conduit of each channel in the second set of channels is substantially linear.

13. A heat exchanger according to any one of aspects 1 to 12, wherein the first set of channels and the second set of channels are arranged in a channel matrix through the body, the channel matrix having alternating rows of the first set of channels and the second set of channels.

14. A heat exchanger according to any one of aspects 1 to 13, wherein the first set of channels and the second set of channels are arranged in a channel matrix through the body such that each channel in the first set of channels is arranged in parallel with each channel in the second set of channels.

15. A heat exchanger according to any one of aspects 1 to 14, wherein the first set of headers are arranged on the body in a first orientation such that a first fluid received by the first set of headers flows in a first direction and the second set of headers are arranged on the body in a second orientation such that a second fluid received by the second set of headers flows in a second direction, the first direction being opposite the second direction.

16. A heat exchanger module adapted to receive high temperature, high pressure, and corrosive fluids, the heat exchanger module comprising: a plurality of heat exchangers, each heat exchanger in the plurality of heat exchangers includes: a body; a first set of channels integrally formed through the body; a first set of headers integrally formed with the body and fluidly coupled to the first set of channels; a second set of channels integrally formed through the body; and a second set of headers integrally formed with the body and fluidly coupled to the second set of channels; wherein, a first heat exchanger of the plurality of heat exchangers is fluidly coupled to a second heat exchanger of the plurality of heat exchangers (a) in series, (b) in parallel, or (c) in series and parallel.

17. A heat exchanger module according to aspect 16, wherein the first set of channels of the first heat exchanger is coupled to the first set of channels of the second heat exchanger, and the second set of channels of the first heat exchanger is coupled to the second set of channels of the second heat exchanger.

18. A heat exchanger module according to aspect 16 or 17, wherein the first heat exchanger of the plurality of heat exchangers is spaced away from the second heat exchanger of the plurality of heat exchangers by a distance.

19. A heat exchanger module according to any one of aspects 16 to 18, wherein a first header in the first set of headers of the first heat exchanger is coupled to a second header in the first set of headers of the second heat exchanger; and wherein a first header in the second set of headers of the first heat exchanger is coupled to a second header in the second set of headers of the second heat exchanger.

20. A heat exchanger module according to any one of aspects 16 to 19, wherein each channel in the first set of channels includes a first inlet, a first outlet, and a first conduit extending between the first inlet and the first outlet, the first conduit having a uniform shape along a length of the first conduit; and wherein, each channel in the second set of channels includes a second inlet, a second outlet, and a second conduit extending between the second inlet and the second outlet, the second conduit having a uniform shape along a length of the second conduit.

21. A heat exchanger adapted to receive high temperature, high pressure, and corrosive fluids, the heat exchanger comprising: a body having an interior volume defined by a top side, a bottom side, a first side, a second side, a third side, and a fourth side; a first set of channels adapted to receive a first fluid having a first temperature and a first pressure, each channel in the first set of channels includes: a first inlet; a first outlet; and a first conduit extending between the first inlet and the first outlet, the first conduit having a uniform shape from the first inlet to the first outlet; a first set of headers at least partially disposed within the interior volume of the body and fluidly coupled to the first set of channels; a second set of channels adapted to receive a second fluid having a second temperature and a second pressure, each channel in the second set of channels includes: a second inlet; a second outlet; and a second conduit extending between the second inlet and the second outlet, the second conduit having a uniform shape from the second inlet to the second outlet; and a second set of headers at least partially disposed within the interior volume of the body and coupled to the second set of channels; wherein, the first set of channels and the second set of channels are disposed in the interior volume of the body such that each channel in the first set of channels is arranged in parallel with each channel in the second set of channels.

22. A heat exchanger according to aspect 21, further comprising a set of storage channels wherein each storage channel in the set of storage channels is adapted to receive a phase change material, the set of storage channels being disposed between the first set of channels and the second set of channels.

23. A heat exchanger according to aspect 21 or 22, wherein the body has a length equal to approximately 1 meter.

24. A heat exchanger according to any one of aspects 21 to 24, wherein a center of each channel in the first set of channels is spaced from a center of each channel in the second set of channels by a distance of approximately 7.2 millimeters.

25. A heat exchanger according to any one of aspects 21 to 24, wherein each channel in the first set of channels and each channel in the second set of channels has a diameter of approximately 10 millimeters and a height of approximately 2 to 6 millimeters.

26. A heat exchanger according to any one of aspects 21 to 25, wherein each channel in the first set of channels and each channel in the second set of channels has a generally rectangular shape, wherein each corner of the generally rectangular shape is elliptical.

27. A heat exchanger according to any one of aspects 21 to 26, wherein the first set of headers are arranged on the body in a first orientation such that the first fluid received by the first set of headers flows in a first direction and the second set of headers are arranged on the body in a second orientation such that the second fluid received by the second set of headers flows in a second direction, the first direction being opposite the second direction.

28. A method of manufacturing a heat exchanger using additive manufacturing, the method comprising: (a) creating, via a modeling application, a model of the heat exchanger based on a set of parameters, the molding application being stored on a memory of a computing device and executed on a processor of the computing device; (b) distributing a layer of powder on a building platform; (c) selectively applying a binding agent, via a carriage, to the layer of powder based at least in part on the model of the heat exchanger created by the modeling application thereby creating a printing area, where some particles in the layer of powder are bound together via the binding agent, and a material area, where each particle in the layer of powder is separate from each other particle in the layer of powder; (d) translating the building platform in a direction away from the carriage by a distance, the distance being greater than a thickness of the layer of powder; (e) repeating steps (b)-(d) until the heat exchanger is formed.

29. A method according to aspect 28, wherein selectively applying the binding agent includes applying the binding agent to the layer of powder such that the printing area is continuous.

30. A method according to aspect 28 or 29, wherein selectively applying the binding agent includes applying the binding agent to the layer of powder such that the printing area includes at least one void.

31. A method according to aspect 30, wherein the at least one void corresponds to at least one of (a) a channel in the first set of channels, (b) a channel in the second set of channels, (c) a header in the first set of headers, or (d) a header in the second set of headers.

We claim:

1. A heat exchanger adapted to receive high temperature, high pressure, and corrosive fluids, the heat exchanger comprising:
a body having an interior volume;
a first set of channels extending through the body, each channel in the first set of channels having:
a first inlet aperture;
a first inlet portion;
a first outlet aperture;
a first outlet portion; and
a first conduit extending between the first inlet portion and the first outlet portion;
wherein the first conduit has a first cross-sectional shape that is constant as the first conduit extends between the first inlet portion and the first outlet portion;
wherein the first cross-sectional shape is defined by a rectangular flow area, a first semi-elliptical flow area disposed outward from a first side of the rectangular flow area, and a second semi-elliptical flow area disposed outward from a second side of the rectangular flow area opposite the first side of the rectangular flow area such that the second semi-elliptical flow area is disposed opposite the first semi-elliptical flow area; and
wherein the first cross-sectional shape is configured to maintain stress below 65 megapascals (MPa) in the body when a first fluid, at a first pressure between 175 bar and 700 bar, is received in the first set of channels;
a second set of channels extending through the body such that the second set of channels is spaced from the first set of channels by a distance, each channel in the second set of channels having:
a second inlet aperture;
a second inlet portion;
a second outlet aperture;
a second outlet portion; and
a second conduit extending between the second inlet portion and the second outlet portion;
wherein the second conduit has a second cross-sectional shape that is constant as the second conduit extends between the second inlet portion and the second outlet portion; and
wherein each channel in the second set of channels is adapted to receive a second fluid at a second pressure different from the first pressure;
a first set of headers including both horizontal and vertical components and seamlessly formed with the body, the first set of headers in fluid communication with each channel in the first set of channels; and
a second set of headers including both horizontal and vertical components and seamlessly formed with the body, the second set of headers in fluid communication with each channel in the second set of channels,
wherein each channel in one of the first set of channels and second set of channels has a height of approximately 1 to 20 millimeters and a diameter of approximately 1 to 20 millimeters.

2. The heat exchanger of claim 1, further comprising a set of storage channels integrally formed with and extending through the body, each storage channel in the set of storage channels being adapted to receive a thermal storage material, the set of storage channels being disposed between the first set of channels and the second set of channels.

3. The heat exchanger of claim 1, wherein a shape of the first inlet portion and a shape of the first outlet portion are substantially similar to the shape of the first conduit, and a shape of the second inlet portion and a shape of the second outlet portion are substantially similar to the shape of the second conduit,
wherein, the shape of at least one of the first inlet portion or the second inlet portion includes a semi-elliptical cross-section.

4. The heat exchanger of claim 1, wherein the first set of channels is adapted to receive a first fluid having a temperature between 500° C. and 800° C., and the second set of channels is adapted to receive a second fluid having a temperature between 500° C. and 800° C., the first fluid being a corrosive fluid.

5. The heat exchanger of claim 1, wherein the horizontal and vertical components of the first set of headers includes a first vertical portion and at least one first horizontal portion, each horizontal portion of the at least one first horizontal portion being in fluid communication with the first vertical portion; and
wherein, the horizontal and vertical components of the second set of headers includes a second vertical portion and at least one second horizontal portion, each horizontal portion of the at least one second horizontal portion being in fluid communication with the second vertical portion.

6. The heat exchanger of claim 1, wherein the first set of channels and the second set of channels are arranged in a channel matrix through the body, the channel matrix having alternating rows of the first set of channels and the second set of channels.

7. The heat exchanger of claim 1, wherein a center of each channel in the first set of channels is spaced from a center of each channel in the second set of channels by a distance of approximately 7.2 millimeters.

8. The heat exchanger of claim 1, wherein each channel in the first set of channels and each channel in the second set of channels has a diameter of approximately 10 millimeters.

9. The heat exchanger of claim 1, wherein the heat exchanger is formed using an additive manufacturing technique.

10. The heat exchanger of claim 9, wherein the heat exchanger is formed of ceramic.

11. The heat exchanger of claim 1, wherein the second pressure is between 0 bar and 20 bar.

12. The heat exchanger of claim 1, wherein the first set of headers extends from a top side of the body and the second set of headers extends from a bottom side of the body.

13. A solar powered energy generation system comprising the heat exchanger of claim 1.

14. A heat exchanger module adapted to receive high temperature, high pressure, and corrosive fluids, the heat exchanger module comprising:
a plurality of heat exchangers, each heat exchanger in the plurality of heat exchangers includes:
a body;
a first set of channels integrally formed through the body each channel defining a first conduit having a cross-sectional shape that is constant along an entire length of the first conduit, the cross-sectional shape defined by a rectangular flow area, a first semi-elliptical flow area disposed outward from a first side of the rectangular flow area, and a second semi-elliptical flow area disposed outward from a second side of the rectangular flow area opposite the first side of the rectangular flow area such that the second semi-elliptical flow area is disposed opposite the first semi-elliptical flow area, the cross-sectional shape configured to maintain stress below 65 megapascals (MPa) in the body when a first fluid at a first pressure between 175 bar and 700 bar is received in the first set of channels;
a first set of headers including both horizontal and vertical components and seamlessly formed with the body, the first set of headers fluidly coupled to the first set of channels;
a second set of channels integrally formed through the body adapted to receive a second fluid at a second pressure different than the first pressure; and
a second set of headers including both horizontal and vertical components and seamlessly formed with the body, the second set of headers fluidly coupled to the second set of channels; and
a set of storage channels seamlessly formed with and extending through the body, each storage channel in the set of storage channels being adapted to receive a thermal storage material, the set of storage channels being disposed between the first set of channels and the second set of channels;
wherein a first heat exchanger of the plurality of heat exchangers is fluidly coupled to a second heat exchanger of the plurality of heat exchangers (a) in series, (b) in parallel, or (c) in series and parallel.

15. The heat exchanger module of claim 14, wherein the first set of channels of the first heat exchanger is coupled to the first set of channels of the second heat exchanger, and the second set of channels of the first heat exchanger is coupled to the second set of channels of the second heat exchanger.

16. The heat exchanger module of claim 14, wherein a first header in the first set of headers of the first heat exchanger is coupled to a second header in the first set of headers of the second heat exchanger; and
wherein a first header in the second set of headers of the first heat exchanger is coupled to a second header in the second set of headers of the second heat exchanger.

17. A heat exchanger, comprising:
a ceramic body having an interior volume;
a first set of channels extending through the body, each channel in the first set of channels having:
a first inlet aperture;
a first inlet portion;
a first outlet aperture;
a first outlet portion; and
a first conduit extending between the first inlet portion and the first outlet portion, the first conduit includes a first cross-sectional shape having a rectangular flow area, a first semi-elliptical flow area disposed outward from a first side of the rectangular flow area, and a second semi-elliptical flow area disposed outward from a second side of the rectangular flow area opposite the first side of the rectangular flow area such that the second semi-elliptical flow area is disposed opposite the first semi-elliptical flow area, the cross-sectional shape configured to maintain stress below 65 megapascals (MPa) a first fluid at a first pressure between 175 bar and 700 bar;
a second set of channels extending through the body such that the second set of channels is spaced from the first set of channels by a distance, each channel in the second set of channels having:
a second inlet aperture;
a second inlet portion;
a second outlet aperture;
a second outlet portion; and
a second conduit extending between the second inlet portion and the second outlet portion, the second conduit includes a second cross-sectional shape having a rectangular flow area, a first semi-elliptical flow area enclosing a first side of the rectangular flow area, and a second semi-elliptical flow area enclosing a second side of the rectangular flow area and the second semi-elliptical flow area disposed opposite the first semi-elliptical flow area,
wherein each channel in the second set of channels is adapted to receive a second fluid at a second pressure different than the first pressure;
a set of storage channels seamlessly formed with and extending through the body, each storage channel in the set of storage channels being adapted to receive a thermal storage material, the set of storage channels being disposed between the first set of channels and the second set of channels;
a first set of headers including both horizontal and vertical components and seamlessly formed with the body, the first set of headers in fluid communication with each channel in the first set of channels; and
a second set of headers including both horizontal and vertical components and seamlessly formed with the body, the second set of headers in fluid communication with each channel in the second set of channels.

18. The heat exchanger of claim 17, wherein each channel in the first set of channels and each channel in the second set of channels has a diameter of between approximately 5 millimeters (mm) and 10 mm.

19. The heat exchanger of claim 18, wherein each channel in the first set of channels and each channel in the second set of channels has a diameter of between approximately 5 millimeters (mm) and 7 mm.

20. The heat exchanger of claim 17, wherein each channel in the first set of channels and each channel in the second set of channels has a height of between approximately 1 millimeter (mm) and 3 mm.
